(19) United States
(12) Patent Application Publication
(10) Pub. No.: US 2022/0194680 A1
(43) Pub. Date: Jun. 23, 2022

(54) SYSTEMS AND APPARATUS FOR HYDRATION AND SUPPLEMENTATION

(71) Applicant: AQ Nutrition LLC, Duxbury, MA (US)

(72) Inventor: Paal Gisholt, Duxbury, MA (US)

(21) Appl. No.: 17/687,113

(22) Filed: Mar. 4, 2022

Related U.S. Application Data
(63) Continuation of application No. 17/130,623, filed on Dec. 22, 2020.
Application No. 17/130,623 is a continuation of application No. PCT/US2019/038781, filed on Jun. 24, 2019.
(60) Provisional application No. 62/749,085, filed on Oct. 22, 2018.
(60) Provisional application No. 62/688,524, filed on Jun. 22, 2018.

(51) Int. Cl. B65D 81/32; A47J 36/32; A47J 31/40; B65D 25/08; A47G 19/16; A47J 41/00; B65D 5/48; B65D 25/04; B65D 25/10; B65D 65/46; B65D 71/50; B65D 77/20; B01F 33/501; B01F 35/221

(52) U.S. Cl. CPC B65D 81/3211; B01F 2101/14; A47J 31/407; B65D 25/08; A47G 19/16; A47J 31/40; A47J 41/005; B65D 5/48; B65D 25/04; B65D 25/108; B65D 65/463; B65D 65/466; B65D 71/50; B65D 77/2028; B01F 33/50111; B01F 35/2215; B65D 77/2056; A47J 2203/00; B65D 2203/10; A47J 36/321

(57) ABSTRACT

In one aspect, new dispenser components for use with portable fluid dispensing apparatus are provided. The present systems can by used to administer to a user water and other fluids optionally together with one or more other ingestibles such as flavoring, or a health supplement. In another aspect, new rotor or disk units that may comprise one or more pods or packets that contain ingestible material(s). In a further aspect, one or more of such pods or packets that may comprise one or more ingestible materials.

### CROSS-REFERENCE TO RELATED APPLICATIONS

This application claims priority to U.S. Provisional Application No. 62/688,524, filed on Jun. 22, 2018 and U.S. Provisional Application No. 62/749,085 filed on Oct. 22, 2018. The entire contents of the aforementioned patent applications are incorporated herein by this reference.

### 1. FIELD

In one aspect, new dispenser components for use with portable fluid dispensing apparatus are provided. The present systems can be used to administer to a user water and other fluids optionally together with one or more other ingestibles such as flavoring, a health supplement, or a meal replacement. In another aspect, new rotor or disk units that may comprise one or more pods or packets that contain ingestible material(s). In a further aspect, one or more of such pods or packets that may comprise one or more ingestible materials.

### 2. BACKGROUND

Human dietary supplements are used by a significant portion of the population. These supplements may be used to 1) provide a general dietary/nutritional benefit, 2) provide improved physical performance (as with sports nutrition), or 3) improve a functional aspect of the body (lipid control/heart health, stress management, weight loss, slowing the aging process, improved sleep, etc.).

With so many supplements available, individuals who value supplements as part of daily care are often taking 10 or more pills per day. This can be an excessive amount of pills. It is estimated that about 40% of the population has an aversion to swallowing pills. Some individuals report heartburn with pills and even worse heartburn with numerous pills. In addition, some individuals find taking three batches of pills day after day to be tiresome—a phenomenon sometimes dubbed “pill fatigue.”

It would be desirable to have new systems and methods for administering supplements and other ingestible materials (ingestibles).

### SUMMARY

We now provide a new personal portable fluid dispensing apparatus. We also provide a new dispensing or rotor unit configured for use with the portable fluid dispensing apparatus as well as new packets or pods configured for use in the dispensing unit.

A preferred portable fluid dispensing apparatus comprises a vessel component for retaining fluid and a dispenser component that is in communication with the vessel component. The dispenser component is adapted to retain two or more ingestible materials that can be selectively added to the vessel component. The ingestible materials preferably contain at least two different material types. The vessel component also comprises a mixer component which may be automatically activated in response to the ingestible materials being dispensed into the vessel component or in response to sensing movement of the apparatus. The mixer component may also be activated based on a stored blending schedule. Alternatively, the mixer component may be manually activated.

The apparatus further comprises a base component attached below the vessel component. The vessel component may have an open end portion that mates with the base component. The base component may be divided into a plurality of compartments. In one aspect, the base component provides temperature control of fluid retained in the vessel component. One or more operation parameters of the apparatus may be manipulated manually or remotely. The operation parameters include temperature of the fluid within the vessel component, addition of one or more ingestible materials to the vessel component, outputs to a user of the apparatus, exposure of contents to ultraviolet (UV) light for sterilization, backlighting of contents with variable color and/or brightness, addition of a secondary fluid (e.g., sweeteners, supplemental nutrients, liquid creamer, and the like), blending of the fluid and the ingestible materials, or scanning of packets via an RFID chip or QR scanning

The base component and the vessel component are releasably affixed and may be releasably engaged by a threaded or similar attachment. The apparatus may further comprise a battery component and a processor. The apparatus and associated app is capable of assessing one or more use parameters, stored user demographics, stored user preferences, user location, motion impact to the apparatus, orientation, pressure, and direction of the apparatus, strain gauge reading, accelerometer, thermistor reading, and optimal hydration based on body weight, exercise, and ambient temperature. This assessed data may be used to determine consumption of liquid. The use parameters include levels of fluid contained in the apparatus, amount of ingestible materials contained in the apparatus, type of ingestible materials contained in the apparatus, temperature of fluid contained in the apparatus, power supply levels of the apparatus, location of available proximate fluid supplies, record of user consumption and type of fluid and ingestible materials, and schedule of user consumption of fluid and ingestible materials.

The indication of levels of fluid contained in the apparatus may be provided by a plurality of light emitting diodes (LEDs). In a preferred embodiment, the vessel compartment includes a transparent panel to provide a visual indication of levels of fluid contained in the apparatus.

In one embodiment, the dispenser component is configured to nest and selectively dispense one or more ingestible materials. In another embodiment, the dispenser component is configured to nest and selectively dispense multiple distinct ingestible materials. In one embodiment, multiple distinct ingestible materials may be dispensed simultaneously.

In one alternate embodiment, the vessel component and the dispenser component are rotatably attached. The attachment may be via a pin rotation, a bore rotation, or a concentric rotation. The dispenser component may be rotated to be laterally offset with respect to the vessel component to dispense the ingestible materials into the vessel component. In one embodiment, the rotation of the dispenser component causes a striker to be rotated towards the dispenser component and release the ingestible materials.

In certain embodiments, the apparatus comprises a drinking tube mechanically connected to the striker. The drinking tube is disposed through a center of the vessel component or outside a diameter of the dispenser component. The drinking tube is rotated into a drinking position to move the striker towards the dispenser component.

In a preferred embodiment, as shown in FIGS. 32A and 32B, the dispenser component comprises a drinking path in communication with the vessel component and external to a path of rotation of the packets of ingestible materials. Alternately, and as described further below and shown in FIGS. 32C and 32D, a cavity of the rotor may provide a flow path from the vessel component, through the dispenser component, and toward the external opening of dispenser component (e.g. mouth piece of a drinking path). In this configuration, an addition mouth piece at the top of the dispenser component is omitted. Instead, an opening is provided in the top of the dispenser component itself to provide a drinking path through the cavity of the rotor. Additionally, the apparatus comprises a handle or lever rotatably coupled to the vessel component. The handle or lever may be rotated downward to lock and seal the dispenser component to the vessel component. The handle or lever is also mechanically connected to the striker and is rotated downward to dispense the ingestible materials into the vessel component by piercing the lidding material sealing the ingestible materials. During engagement of the lever, the lever suitably can traverse a path that is external or separate from and suitably non-parallel to the plane or direction in which contents of the packets are dispersed from packets during use.

Preferably, the overall height of the apparatus is in a range of about 6 to 24 or more inches, more typically a height of 8 to 15 inches. A cross-sectional dimension of the apparatus suitably increases from a bottom portion to the dispenser component. Alternatively, the entire height of the apparatus is substantially uniform. Preferably, the vertical cross-sectional dimension of the apparatus is in the range of about of about 2 inches to about 6, 7, 8, 9, 10 or 12 inches, more typically about 2.5 to 5 inches. In any event, dimensions of the apparatus may suitably vary.

In another alternate aspect, a personal portable fluid dispensing apparatus comprises a vessel component for retaining fluid, a dispenser component configured to retain two or more ingestible materials that can be selectively added to the vessel component. In this configuration, the apparatus can separately store multiple distinct fluids. The vessel component is divided into multiple compartments to store the multiple distinct fluids. A vessel chamber wall divides the vessel component into the multiple compartments. The vessel chamber further comprises a retractable lower portion to fluidly join each compartment of the vessel component. The apparatus is configured to independently dispense multiple distinct fluids to a user.

In additional preferred systems, a dispensing unit is configured for use with the portable fluid dispensing apparatus and comprises a disk unit configured to releasably nest one or more packets of ingestible material. In one embodiment, the disk unit is a multiple-component disk unit. The disk unit comprises cavities shaped to accommodate the packets of ingestible materials. The disk unit further comprises one or more indicators of nested packets of ingestible materials. The indicators may be visual and/or tactile indicators which may be color, textual, or shape-coded. Preferably, the disk unit securely engages the packets via at least one protrusion formed on each packet. In one embodiment, the disk unit contains one or more packets of ingestible materials. Preferably, the dispensing unit contains two or more packets. Additionally, the at least two of the packets may contain different ingestible materials. The different ingestible material is selected based on user selection or is preselected based on user data.

In a further aspect, the disk unit comprises an upper disk part and a lower disk part and the one or more packets are nested between the upper and lower disk parts. The upper and lower disk parts are releasably engaged or alternately, permanently affixed. The upper and lower disk parts may comprise a mechanical engagement. The upper disk and/or the lower disk is configured to releasably engage the one or more packets.

In one alternate embodiment, the disk unit securely engage the one or more packets via at least one protrusion formed on each packet. Alternately, the disk unit comprises featheredged edges that line cavities that allow for the one or more packets to be press fitted into the disk unit.

In further embodiments, the disk unit is configured to securely engage the fluid dispensing apparatus. The dispensing unit further contains one or more of the packets which are labeled for identification by other than visual inspection.

Preferably, the disk unit is configured to nest multiple packets, three to ten packets. In one embodiment the disk unit is configured to nest at least five packets and in another embodiment the disk unit is configured to nest at least three packets.

In preferred aspects, the one or more packets are each wedge shaped and more preferably, are formed as a pie-shaped wedge. Each pie-shaped wedge has rounded corners. The packets further comprise an extended flange configured to engage the disk unit. When the disk unit is loaded or charged, with the packets, the flange of each packet is seated on the disk unit. The packets also comprise a lidding or a lid section. In an alternate embodiment, the lidding dissolves in contact with water. The lidding may be human-ingestible. The packets may also be made of one or more materials that comprise a dissolvable material. The lidding and the packets may be formed of a substantially same material. The packet may be made from materials that comprise PET, PLA, or HIPS. Alternately, the packet is made from materials that comprise a biodegradable polymer and/or a biocompostable polymer. The lidstock of the packets providing access to the ingestible materials may be non-peelable, peelable, or piercable. The lidstock may further comprise a QR code, a lot code, a bar code, or consumer readable information.

In one embodiment, each packet has a scored lidstock that facilitates desired opening. The dispensing unit prevents entry of the lidding materials in a fluid-containing component of the dispensing apparatus. In one embodiment, the packets are configured to prevent entry of lidding material into a fluid-containing component of the portable fluid dispensing apparatus. In a preferred embodiment, the lid section of the one or more packets is only partially scored for dispensing to prevent entry of lidding material into the fluid-containing component of the dispensing unit. The non-scored portion of the lid section is positioned at a leading portion of the packet as the disk unit rotates to prevent inhibiting rotation of the disk unit.

In some embodiments, the disk unit and/or the packets comprise graded edge portions in areas wherein packets are nested. The edge portions may have a bevel or chamfer configuration. Suitably, the graded edge portions reduce or prevent nested packets from inhibiting rotation of the dispensing unit.

In certain aspects, the disk unit and/or one or more packets are formed from recyclable material. The disk unit and/or one or more packets may be formed from polylactic acid or polyethylene terephthalate. The disk unit and packets are each formed from a same substantially material. The disk unit may be made of a compostable material.

The dispensing unit is positioned within a chamber of the portable fluid dispensing apparatus. The chamber may include a retractable door unit to admit the dispensing unit to the chamber. The dispensing unit includes an apparatus to facilitate opening of one or more packets nested within the dispensing unit. The apparatus comprises a lever, a cam, and a hammer. The apparatus may further comprise a door that opens when in a dispense mode and closes when in a drink, storage, or blend mode. The door closes with a seal, preferably actuated by a spring that prevents water from entering the storage chamber in the dispensing unit.

In some embodiments, the disk unit of the dispensing unit is preloaded with packets of ingestible materials based on a user order or user data. Alternately, the dispensing unit itself is preloaded with the packets. The user data includes at least one of questionnaire results, laboratory test results, genetic test results, and body fluid test results. The disk unit further comprises an RFID chip enabling sensing of the ingestible materials dispensed at a particular time. The disk unit may also be reusable. In preferred embodiments, the disk unit is formed of sheet stock having a thickness of about 0.020 to 0.040 inches. The disk unit has a diameter of about 2 to 5 inches.

In a further aspect, a method for charging a fluid dispensing apparatus is provided. The method comprises providing a dispensing unit configured for use with a portable fluid dispensing apparatus, the dispensing unit comprising a disk unit configured to releasably nest one or more dispensable packets of ingestible materials, the disk unit comprising one or more indicators of nested dispensable packets of ingestible materials. The method further comprises adding one or more of the dispensable packets to the disk unit based on one or more sensory indicators provided on either or both of the disk unit and one or more dispensable packets. The packets are then dispensed into the fluid-containing component of the portable fluid dispensing apparatus. The dispensing process may be based on user selection or based on the sensory indicators and may be manually or automatically activated.

In use or upon activation, a portion or substantially all of the ingestible material(s) contained in a packet or pod are dispensed into the vessel unit of the apparatus, for example, at least about 10, 20, 50, 60, 70, 80, 90 or 95% of the total weight of ingestible materials contained within a packet or pod are dispensed into the apparatus upon activation such as tearing or removal of a lidstock.

In certain aspects, the ingestible material contents of a packet or pod contents are accessed and dispensed into the vessel unit of the apparatus by mechanical action only. In certain other aspects, the ingestible material contents of a packet or pod contents are accessed and dispensed into the vessel unit of the apparatus only via an automatic system, such as with use of a control unit. In still other aspects, ingestible material contents of a packet or pod contents are accessed and dispensed into the vessel unit of the apparatus by a combination of mechanical action and an automatic system such as with use of a control unit. The control unit may also be in communication with the various apps discussed herein.

In another aspect, a disk unit configured for use with the portable fluid dispensing apparatus comprises one or more packets of ingestible materials and a label that identifies the person or group of persons selected for consumption of the ingestible materials. The label identifies a content category of the ingestible materials. Preferably, the disk unit comprises two or more packets of ingestible materials. The label may be affixed to the disk unit or may be integrated thereinto.

In preferred aspects, a packet comprises one or more ingestible materials configured for use in the dispensing unit and the packet is detectably labeled. The ingestible material is powder or liquid form. The liquid may be a concentrated liquid nutrient. In one embodiment, the packets comprise one or more indicators that are visual and/or tactile indicators of color, textual, or shape-coded. The packets may comprise contacts/dots, a QR code, or an RFID chip enabling the dispensing apparatus to sense the ingestible material dispensed at a particular time.

Each packet may vary in size and in one aspect preferably has a longest dimension of less than 5, 4 or 3 inches. In another embodiment, each packet has a longest dimension of less than 2 inches. In yet another embodiment, each packet has a longest dimension of less than 1.5 inches. A packet may have a variety of configures or shapes. In a preferred aspect, the packet may have a wedge-shape through an entire dimension length of the packet. In another embodiment, the packet has a wedge-shape through only a portion of a dimension length of the packet.

In an alternate embodiment, the packet has a cylindrical shape for at least a portion of the dimension length of the packet. Alternatively, the packet has a four-sided shape (e.g. square or rectangular cross-section) for at least a portion of a dimension length of the packet. In preferred embodiments, the packet comprises a flat portion opposite to a base portion or lid section of the wedge (e.g. pie-shaped wedge) to engage with a central disk structure of the dispensing unit.

In one aspect, the packets are injection molded. In another aspect, the packets are thermoformed. The thermoformed packets are formed with an aspect ratio of greater than 1:1 and more particularly, with an aspect ratio of 1.5:11. The thermoformed packets are formed with an average draft angle between the flange and the packet bottom of less than about 5 degrees. The packets preferably contain about 1 to 30 grams of ingestible material, and more particularly, about 1 to 12 grams of ingestible material.

In a further system, a packaging unit is provided comprising a plurality of packets of ingestible material. The packaging unit may be a sleeve element, a box element, or a bag element. The packets can be suitably arranged or nested in a packaging unit in a variety of configurations. In one aspect, a plurality of packets are stored within the packaging unit in alternating orientation. In another aspect, the packets are nested within the packaging unit in an abutting matter. On other aspects, such as a bag, the packets may be loosely arranged. The packaging unit comprises at least 2, 3, 4, 5, 6, 7, 8, 9, 10, 12, 14, 16, 18, 20, 22, 24, 26, 28, 30, 32 or more packets and more preferably, comprises 14 packets. In certain aspects, a packaging unit comprises less than 40, 35, 30, 25, 20, 15 or 12 packets.

Other aspects of the invention are disclosed infra.

### BRIEF DESCRIPTION OF THE DRAWINGS

FIGS. 1A-1F schematically shows a suitable dispensing apparatus;

FIGS. 1G and 1H illustrate a detailed view of the dispensing component of the dispensing apparatus;

FIGS. 2A and 2B show a view along line 2-2 in FIG. 1A;

FIGS. 2C and 2D show the distinct drinking paths of FIGS. 2A and 2B;

FIG. 3A shows a side partial cut-away view of a suitable dispensing apparatus;

FIG. 3B shows a dispensing apparatus with a pin rotation;

FIG. 3C shows a dispensing apparatus with a bore rotation;

FIG. 3D shows a dispensing apparatus with a concentric rotation;

FIG. 4 shows a schematic of the adjustable dispensing operation of an apparatus;

FIG. 5-7 shows a further dispensing apparatus having a drinking tube;

FIG. 8 shows a method of charging a dispensing apparatus;

FIG. 9A shows a method of dispensing a packaged ingestible material and blending with a fluid within the vessel;

FIGS. 9B-9D illustrate cross-sectional views of the opening of a packet;

FIGS. 10A-10G shows a packet and a dispenser component with packets nested therein;

FIG. 11 is an illustrative schematic top view of a packaged ingestible material (e.g. pod) that can be nested within a dispenser component;

FIGS. 12A-12F show exemplary thermoformed packets;

FIGS. 13A-13J show exemplary injection molded packets;

FIGS. 14A-F show a thermoformed packet and dispensing operation according to a first exemplary embodiment;

FIGS. 15A-15F show a thermoformed packet and dispensing operation according to a second exemplary embodiment;

FIGS. 16A-16D show a thermoformed packet and dispensing operation according to a third exemplary embodiment;

FIGS. 17A-17D show a thermoformed packet and dispensing operation according to a fourth exemplary embodiment;

FIGS. 18A-18D show a thermoformed packet and dispensing operation according to a fifth exemplary embodiment;

FIGS. 19A-19C show a thermoformed packet and dispensing operation according to sixth exemplary embodiment;

FIG. 20 shows a thermoformed packet and dispensing operation according to a seventh exemplary embodiment;

FIGS. 21A-21D show a thermoformed packet and a dispensing operation according to an eighth exemplary embodiment;

FIGS. 22A-22D show an injection molded packet and a dispensing operation according to a first exemplary embodiment;

FIGS. 23A-23D show an injection molded packet and a dispensing operation according to a second exemplary embodiment;

FIGS. 24A-24D show an injection molded packet and a dispensing operation according to a third exemplary embodiment;

FIGS. 25A-25D show an injection molded packet and a dispensing operation according to a fourth exemplary embodiment;

FIGS. 26A-26D show an injection molded packet and a dispensing operation according to a fifth exemplary embodiment;

FIGS. 27A-27D show an injection molded packet and a dispensing operation according to a sixth exemplary embodiment;

FIGS. 28A-28D show an injection molded packet and a dispensing operation according to a seventh exemplary embodiment;

FIGS. 29A-29D show an injection molded packet and a dispensing operation according to an eighth exemplary embodiment;

FIGS. 30A-30D show an injection molded packet and a dispensing operation according to a ninth exemplary embodiment;

FIGS. 31A-31D show an injection molded packet and a dispensing operation according to a tenth exemplary embodiment;

FIGS. 32A-32F show a drinking path and corresponding cap of a dispensing apparatus;

FIGS. 33A-33B show a packaging unit of packets of ingestible materials;

FIGS. 34A-34F show a packaging unit of packets nested within a rotor;

FIG. 35 shows a bottom fluid addition vessel;

FIG. 36 shows a dispensing apparatus outfitted with a bottom fluid additional vessel; and

FIGS. 37A-37C and FIGS. 38A-38D show a dispensing apparatus configured for dispensing infant formula.

### DETAILED DESCRIPTION

As discussed, new apparatus and related systems and methods are provided that can conveniently administer fluids optionally together with one or more other ingestibles. The present apparatus can manipulate various characteristics of stored fluid, including fluid temperature, gas content (e.g. N₂, CO₂, aeration) and the degree of homogeneity of content of various ingestibles such as health supplements, flavorings, beverages, and the like.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Preferred systems may include one or more of a 1) a flask or vessel component for holding one or more fluids, 2) a dispensing head or component that may be configured to accept a custom disposable supplement (ingestibles), discharge those ingredients into a fluid within the vessel, 3) a rotor component, e.g. disposable, rotatable supplement disk or rotor that suitably contains the specified amount of each supplement (ingestibles) in a separate pod or packaging such as a blisterpak and that may, for example, collectively comprise a desired daily or other periodic or scheduled regimen of supplements for a specific user of the system, suitably placed in a sequential order or other arrangement around the rotor to facilitate optimal time of day administration. In another embodiment, administration of the ingestible material would be facilitated by an application that communicates with the flask (vessel component). The app could be deployed either over personal computers, mobile devices (including mobile phones, tablets such as iPads®), watching, fitness trackers, or the like providing a reminder to the user to hydrate, take supplements at the appointed time, modify hydration recommendations relative to physical activity, either detected, for example by integration with personal exercise fitness tracker apps or mobile phones or by user input.

Such systems and apparatus can provide numerous advantages over other approaches. For instance, the present systems and apparatus permit nutrients (ingestibles) with a stimulatory effect (e.g. B vitamins, astaxanthin) to be administered upon waking and at circadian lulls in mid-morning and mid-afternoon. The present systems and apparatus also permit for nutrients (ingestibles) with sedative effect such as Mg or the amino acid tryptophan to be administered prior to bedtime. The present systems and apparatus would allow water soluble nutrients to be administered between meals, when they are best absorbed and fat soluble nutrients to be administered with fat-containing meals. These systems and apparatus would furthermore allow vitamin C, a potent and rechargeable antioxidant—but which has a 30 minute half-life- to be administered in divided doses over the day, maximizing the effectiveness per mg administered in a day while reducing risk of gastric distress. Dividing the regimen over the course of many administrations could also reduce dose-related off-flavors common with efficacious levels of certain ingredients.

This time of day optimized dispenser component (e.g. rotor charged with one or more pods containing ingestible materials) would also enable the individual to target certain functional nutrients/additives for the time of day they would be most beneficial, such as taking a sleep inducer like valerian or melatonin at night. The present systems and apparatus would also allow nutrients to be delivered more consistently over the course of the day, potentially placing less strain on the liver and kidneys. Finally, some nutrients should not be given at the same time because they compete for binding sites, absorption mechanisms, or other pathways in the body and as well as for other reasons. Such a system would allow those nutrients to be administered at different times. An algorithm (e.g., in the app, on the internet, within the apparatus, in an accessory connected (wired or wirelessly) to the apparatus) collects the relevant information to develop a recommendation and obtains the above factors into account in spreading the doses out for maximum potency/minimal negative effects.

### Vessel Component

In a preferred embodiment, the vessel component (also sometimes referred to herein as the flask or flask component), suitably has a primary tubular body that can function to substantially maintain an established temperature (e.g. above or below room temperature) for an extended period of time such as 1, 2, 3, 4, 5, 6, 8, 10, 12 or more hours of a fluid retained within the flask component. In one embodiment, the flask is made from double or triple walled 316 Stainless Steel with a vacuum between the layers for insulation. In a preferred embodiment, the flask is made of glass which provides a visual indication when filling. When glass is used, a honeycomb rubber liner or the like may be used to reduce provide air pockets for insulations, and provide shock absorption. Plastic, or BPA-free plastic, may be used for certain applications. The drinking path of the apparatus remains free of plastic to reduce exposure to estrogenic activity (EA) chemicals, such as, BPA. Other materials than glass also may be used to provide visual inspection of filling.

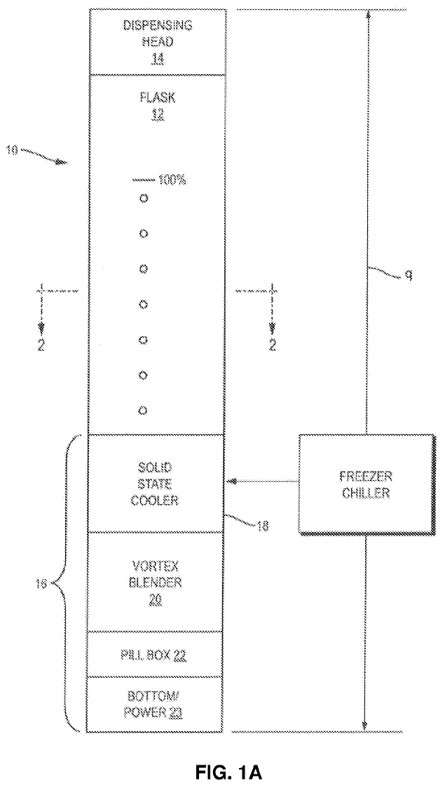

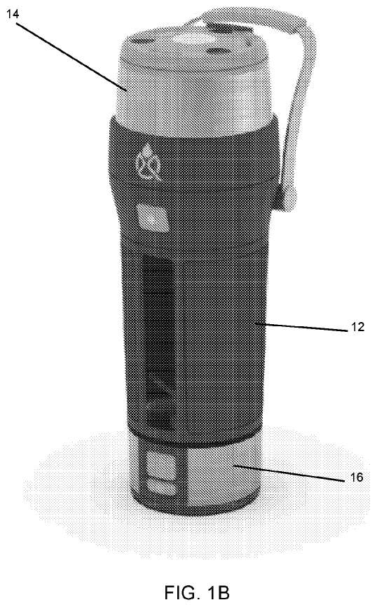

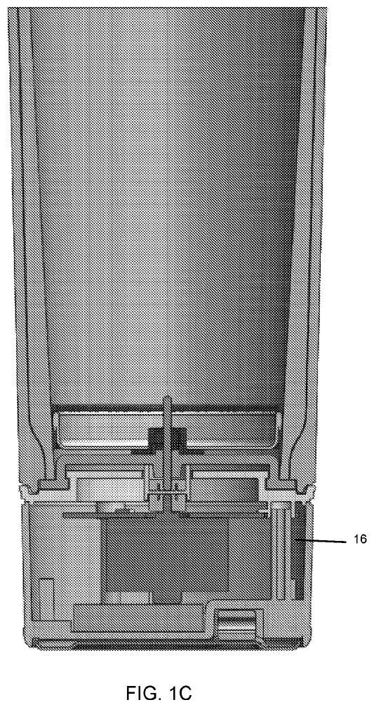

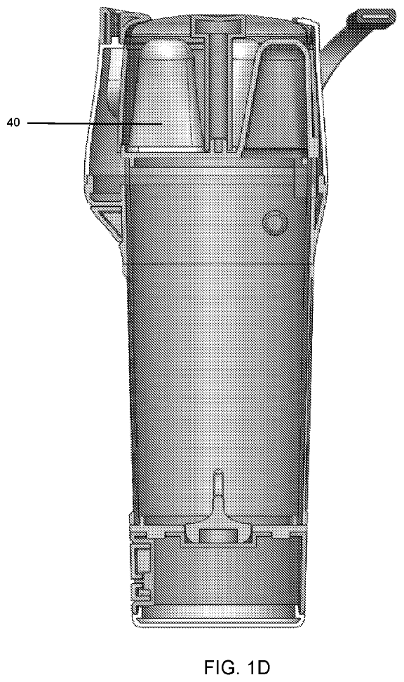

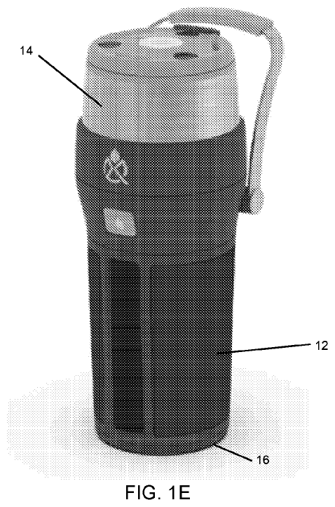

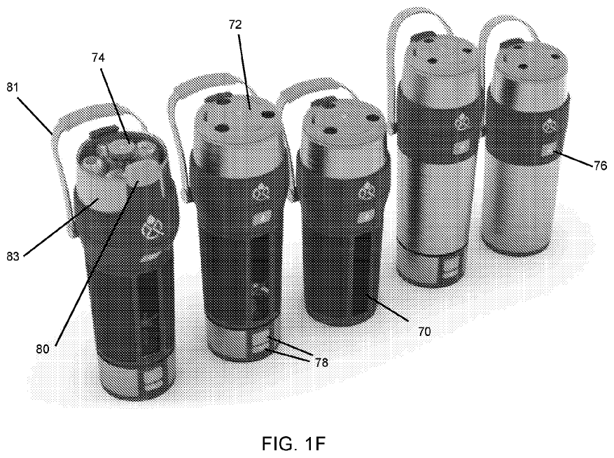

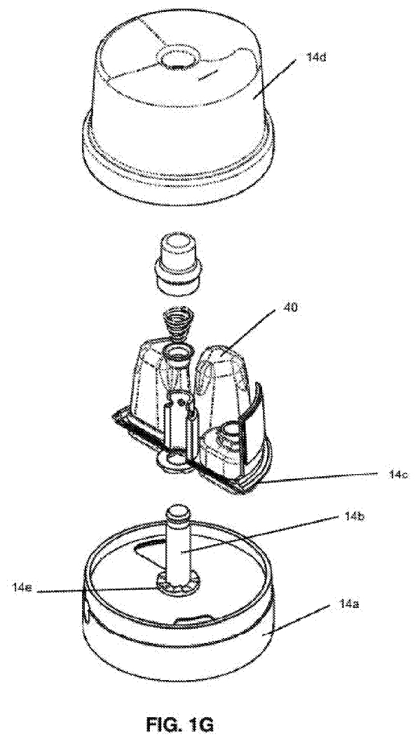

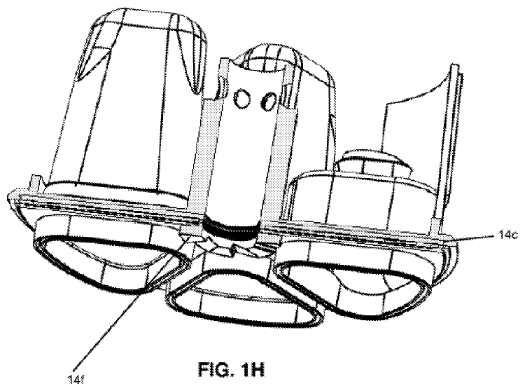

In a preferred embodiment the flask component allows for visual inspection to determine the level of fluid within the flask component such as a transparent window in the flask that allows for such visual inspection. In an alternate embodiment the flask includes a visual or other output of the fluid fill level of the flask component, for example a stack of light emitting diodes (LEDs) disposed up the side that allows visualization of the fill level during filling and while drinking (see FIG. 1A). The LED derived light may originate at diodes placed in a linear fashion up the side of the vessel or it may originate in the base unit and be “piped” using fiber optics or the like to emitting locations in the side of the vessel. The color brightness of the LEDs may also be adjustable as desired. An output including a visual indication such as a flashing light or in addition to level indications, a flashing light ring, may be provided when 1) hydration is suggested or 2) a next dosage of supplements should be taken, or 3) when other notification to a user is desired. Additionally, different colors may be about to provide different indications. For example, a blue color may be output to indicate a hydration or drinking suggestion, a green color may be output for a supplement, and a red color may be output for an urgent drinking/hydration reminder.

In a particular embodiment, the flask component may comprise a spout/pivoting drinking tube external to the circumference of the flask that allows the rotor component to spin freely within the dispensing head and which serves as an anchor point for a levered clamp in the dispensing head to secure the seal between the dispensing head, the flask, and the rotor.

In particular, the dispensing head creates a seal with the dispensing packet via a rotating motion, lifting the disk off the seal to enable rotation (see FIGS. 1G-1H). The system suitably makes use of seals (e.g., O-rings or other compliant sealing component), preferably made from silicone (platinum-cured), to provide a tight seal between the flask, the dispensing head, the rotor, the dispensing collar, the flask's bottom cap, and the flask's swappable components (described below). The seal may also be adjustable to accommodate the rotor component charged with pods of ingestible materials or to accommodate the pods charged directly into the dispensing head.

In a particular preferred arrangement, the flask has a removable bottom section/battery pack/processor. The top of this section also suitably may be vacuum insulated stainless steel and secured with a seal. This section suitably includes a power source such as a high power density rechargeable battery pack (preferably lithium ion, but may be substituted with another consumer safe battery capable of powering all or separately the various features of the dispensing apparatus such as, for example 1) the LED lights to indicate fluid level/time to drink, 2) the processor, 3) Bluetooth® radio or the like, 4) locator/finder signal, 5) the swappable components, 6) recharging external devices, such as a cell phone, GoPro®, etc., 7) an optional ultraviolet C (UVC) light used to disinfect water within the flask, 8) frother (e.g., milk frother), and 9) heating device. This battery section suitably is rechargeable with a commercially available micro USB or a USB-C connector. In addition to receiving a charge, the USB-C connector may provide a charge via a stored pigtail connector to charge a mobile phone or other mobile device. This base section may be removed to allow attachment of any of a series of swappable components between the flask and the battery unit.

The first swappable component may be a mixer component (e.g. vortex mixer or blender) that operates at high speed but with a gentle blade to allow complete mixing of powders or liquids while avoiding shearing/denaturing the active ingredients in the various products, as shown in FIG. 1A. The mixer component may have a retractable blade to allow stacking with other components under the flask. Alternatively, in one embodiment, the mixer component may be mounted in the bottom of the flask in a configuration where no swappable components are added to a bottom of the flask. This configuration is exemplarily shown in FIG. 1E where the apparatus includes the dispensing unit and the vessel component within a blender disposed therein.

The second swappable component may be a solid state cooler that pulls heat from the bottom of the flask, as shown in FIG. 1A. This cooler is capable of chilling an insufficiently cool liquid to a preferred, cooler temperature. A small fan, optimized for dB output, will be used to dispel heat from the hot side of the cooler.

Another optional component is a deep freeze head (e.g., freezer/chiller), as shown in FIG. 1A, which suitably has a metallic, such as stainless-steel, surface facing the bottom of the flask, but in this case the stainless steel part in contact with the fluid in the flask is not vacuum insulated. Alternately, a rubber surface is provided to prevent the breakage of the glass bottom of the flask. Rather, this component is designed to chill the fluid in the flask via contact with the stainless-steel surface. Within the deep freeze head is a water chamber. When placed in the freezer, the water in the freezer head undergoes a phase change to ice. The deep freeze head is then fastened in intimate contact with the liquid in the flask where the heat in the fluid initiates a phase change that takes place as the ice in the deep freeze head melts. This phase change absorbs more calories than a solid block of cold steel, with less weight. Multiple deep freeze heads may be placed in the freezer and changed over the course of a day/week. In an alternative embodiment, a replaceable freezable chiller insert that is also filled with water may be inserted in the flask. The insert has an upper section that maintains the log positioned axially central in the flask, avoiding the rotor blades, to prevent damage to the blades of the rotor by the chiller insert.

Another swappable component may be a pill compartment, as shown in FIG. 1A, the void of which may either be hand filled or may accept a 2, 3, or 4 or more section divided disposable cup that may be supplied on a monthly continuity program to the user. The pill compartment suitably 1) accommodates either prescription or non-prescription medications or supplements that are either not appropriate for an aqueous administration (e.g. certain pharmaceuticals, fish oil gel caps), 2) accommodates individuals who want to continue to use a different brand of supplement not offered as part of the system, 3) accommodates an individual who takes more supplements than the rotor system is able to accommodate. Empty reusable, stackable cups may be provided to allow the user to prefill a week's worth of tag along supplements/medications.

Another swappable component may be a protein powder component that suitably accommodates protein powder or other high volume powders that may not fit in the rotor's individual wells. Yet another swappable component may be an enhanced speaker capable of outputting user preferred audio. The speaker may also be programmed to output an alert or alarm to a user related to a scheduled drinking cycle or other user preferred schedules. Additionally, the speaker may comprise an upper and lower disk and may be opposed to the sides by a spiral rail that opens up space between the top and bottom disks for improved acoustics.

The above-described components suitably have threaded or similar attachments at top and bottom and may be stacked in any order, with an electrical contact running through the components. A simple bottom cap may be moved to the bottom-most section to complete the apparatus or provide a base thereto and may provide a mar-free insulated bottom of the flask.

### Dispensing Component

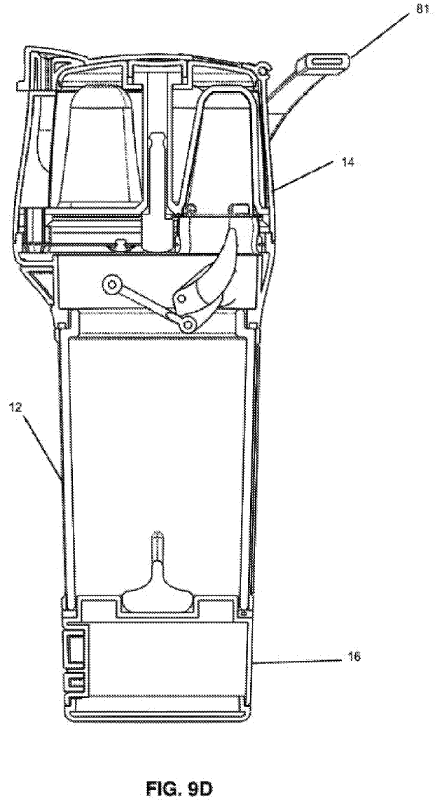

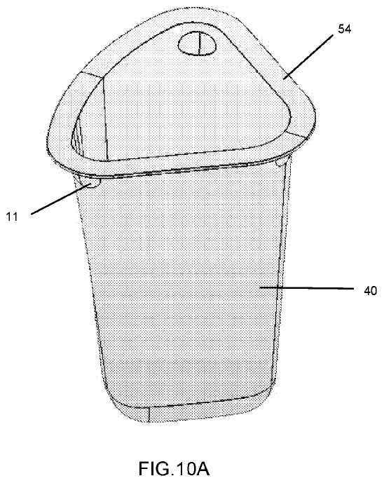

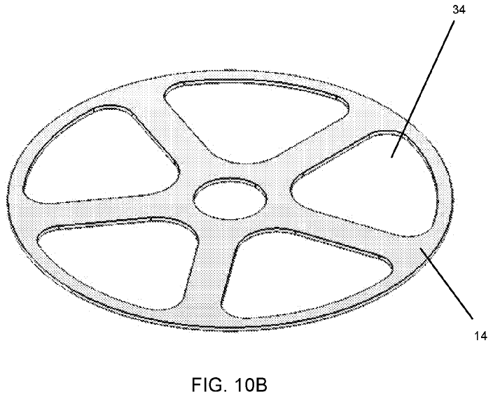

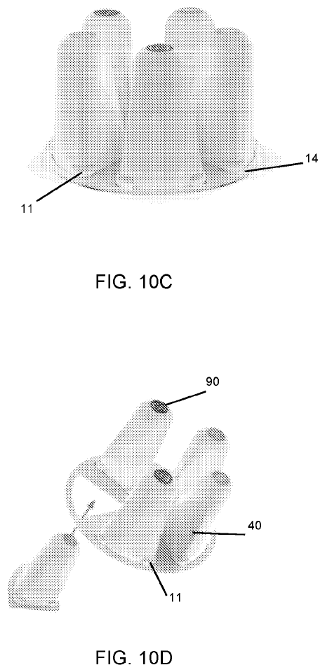

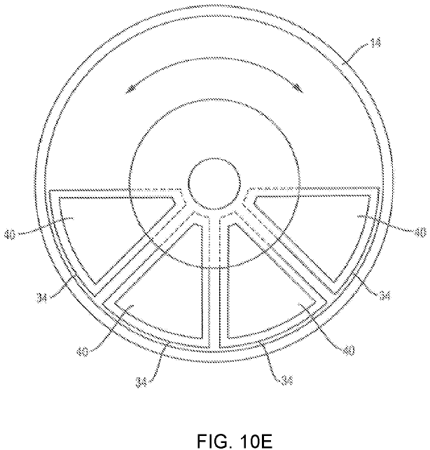

In a preferred embodiment, the dispensing head or component (e.g., dispenser component) is preferably configured to 1) open and receive a rotor with a variable number of cavities, e.g. 3 to 10, located in different positions around the rotor, as exemplarily shown in FIGS. 10C-10D and 10G to accommodate at least one or more packets, 2) allow the rotor to be rotated and positioned based on the desired supplement or drink that has been selected for dispensing, and 3) allow the lidstock/film sealing the bottom of the wedge-shaped pod to be pierced by an upward moving striker, hammer, or ball that leaves at least one side of the lidstock attached. Other alternative openings methods of the lidstock will be described below with reference to the drawings. When the contents of the pod nested in the rotor cavity are released into the fluid within the flask, the flask is ready to be shaken by hand or blended using the blender component.

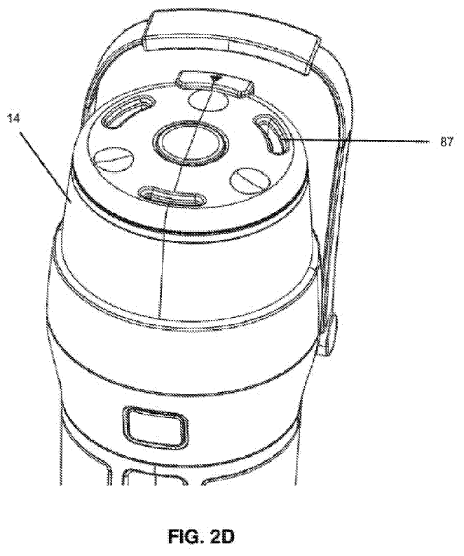

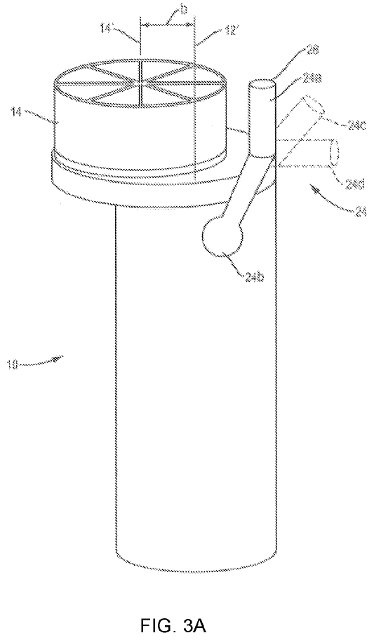

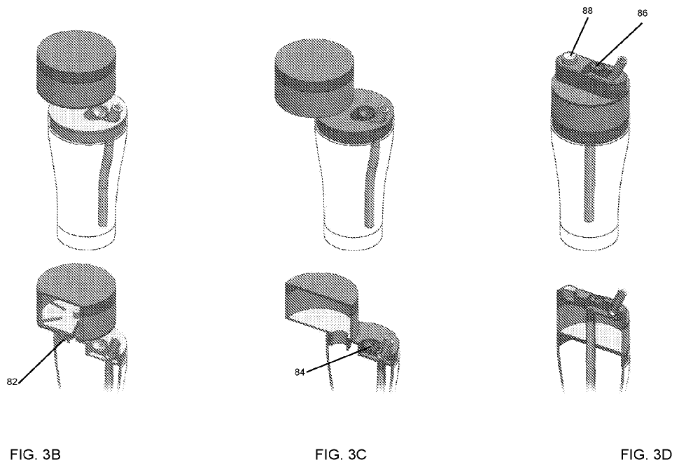

More specifically, in a particular configuration, the dispensing head suitably comprises a lower member (14a in FIG. 1G) that is secured to the flask such as via threads or similar attachment, that has a central, up-facing pivot point (14b in FIG. 1G) that allows the rotor to spin radially, a seal (14c in FIG. 1G-14H) between the rotor and the dispensing head, and a multiple position (e.g., 3-position) lever/drinking tube that has a drinking position where the lever applies pressure, sealing the rotor to the seal, a middle (unsealed) position where the rotor is in contact with the seal but is free to spin, and a third position where the drinking tube/lever is tucked away toward the center of the dispensing head, applying pressure to seal all contents from accidental spillage, as shown in FIG. 3A. However, other configurations are contemplated where a drinking path is provided without a drinking tube. This configuration will be described below in reference to the drawings.

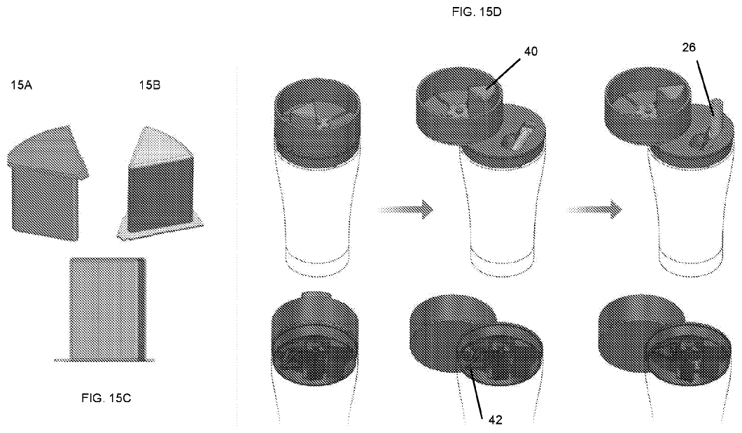

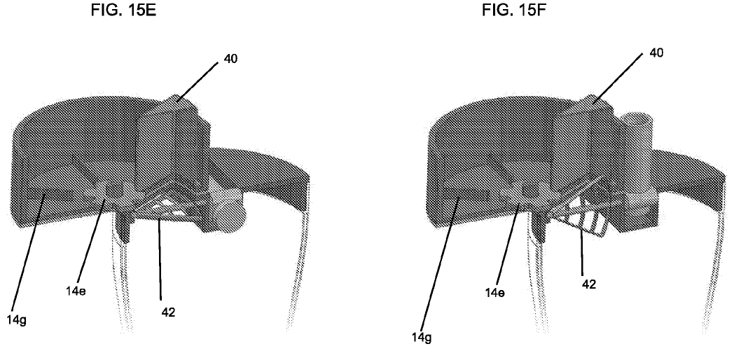

The dispenser component also suitably has a top member (14d in FIG. 1G) that engages with the disposable rotor and pods that have been placed within the dispensing head. This top member of the rotor head preferably has tabs/detents radially around the head for leverage when advancing the rotor. The top also has blades/walls (14g in FIGS. 15E-15F) creating individual chambers that occupy the spaces between the pods in rotor. This top head preferably has one or more windows that allow the user to see the printed contents (e.g., content labeling) on the bottom of each packet nested within the rotor, which is suitably placed upside down in the dispensing head. This top member suitably spins on the same axis as the rotor, and this allows it to position the rotor such that the preferred supplement is in a dispensing station (e.g., a position within the dispenser component at which the pod may be opened by a striker or the like). Once located at the dispensing station or position, the user moves the lever into the piercing position, causing a striker (e.g. ball shaped or similar) to rotate (move) upwards and bluntly rip open a section of the lidstock (e.g. lidstock may be laser pre-scored) in the underside of the packet, releasing the contents (e.g., powder or liquid) into the fluid.

In particular embodiments, it is important to the proper functioning of the device that 1) the flask must be completely sealed when the drinking spout is centrally stored, 2) that it be easy to spin the rotor, even if some particulate matter is stuck in the packet/lidstock/seal interface, 3) that the piercing blade (element) of the striker fully opens the packet but does not leave pieces of lidstock in the resulting beverage, 4) that the piercing blade (element) limits exposure to fingers of the user during cleaning, 5) that the rotor be sealed when the drinking tube is in the sealed/closed position to prevent migration into the chamber in which the rotor sits (e.g., using an articulating door with a seal that prevents interaction between the fluid and the lidstock material, activated by the same mechanism that moves the striking hammer or striker), 6) that the flask be easy to clean between beverages and 7) that the dispensing head be easy to clean, and/or 8) that the dispensing head not allow more than a modest amount of cross contamination between packets of supplements.

### Rotor Unit

In a particularly preferred embodiment, the disposable rotor system comprises several components including a central disk structure, individual pie-shaped wedge thermoformed plastic pods, sealed with lidstock (e.g., plastic, foil, paper or some combination thereof), an optional RFID chip, a custom label with, for example, the users' name, bar code, use by date, content category, or other type of indicator, and the up to preferably 3, 4, 5, 6, 7, or 8, particularly 3 and 5, individual products within the rotor (but which number may suitably range e.g. from 3 to 16). The custom label may be either affixed to the disk structure or integrated thereinto.

In one alternate embodiment, the central disk structure may be a central “sandwich” disk structure that suitably comprises two snap together thermoformed discs, for example approximately 1-4 inches in diameter, preferably about 1.5 to 3 inches in diameter, including 2 inches in diameter. The top disk is suitably flat on top and receives a label. On the underside of the top disk preferably are struts that engage with the notches in the wedges (e.g., blisters, packets, etc.) to hold the wedges removably in place. This top disk's struts suitably snaps into the bottom disk in a permanent manner. The top of the bottom disk has struts similar to the top disc, also engaging with the wedge. When top and bottom are snapped together, the disc has multiple (e.g., 3, 4, 5, 6, 7, 8 or more), openings or cavities to receive multiple pods or packets (e.g., wedges) filled with ingestible materials per the user's specification. In other words, the struts provide a spacing between the top disk and bottom disk and the wedges or pods are inserted therebetween. In one embodiment, to facilitate insertion, the upper disk has a larger radius than the lower disk (e.g. about ⅛ inch larger radius), and the lower disk has a downward flair (e.g. about a 1, 2, 3, 3, 5 or 4 inch or more radius) to create a larger gap between the top and bottom of the disk to create a larger and more preferable insertion target.

In a preferred embodiment, the disk structure is formed as one single unit having a plurality of cavities in which the packets are nested. The disk structure may engage with the packets via at least one protrusion formed on each packet. The rotor is preferably formed of a flat sheet stock having a thickness of about 20 or 40 mils, although other thicknesses and materials of construction also will be suitable. The cavities in the rotor are formed with a particular tolerance to allow for heat/cold expansion while accommodating the packets or pods. The rotor may also be made of a dissolvable, recyclable, or a compostable material and may be reusable. In other words, the rotor may be reloaded or recharged with new packets once one of packets have been opened for dispensing contents into the fluid.

In another alternate embodiment, the disk structure eliminates the need for the protrusions. Instead, the rotor is formed with featheredged slots or cavities which allow for a press or compression fit of the pods to hold the pods in place. Further, the pods may have graded edge portions having a bevel or chamfer configuration. Additionally, the disk structure or rotor, facilitates recyclability by increasing the overall size of the pods, such that the unit is prevented from falling through grates at a recycling facility.

Additionally, the rotor may be preloaded with pods or packets based on a variety of collected information. For example, the rotor may be preloaded based on questionnaire results, laboratory test results, genetic test results, body fluid test results (e.g., blood, urine, saliva), and the like. The rotors with a variable number of cavities may be used and specifically, the packets may be nested into different rotor configurations.

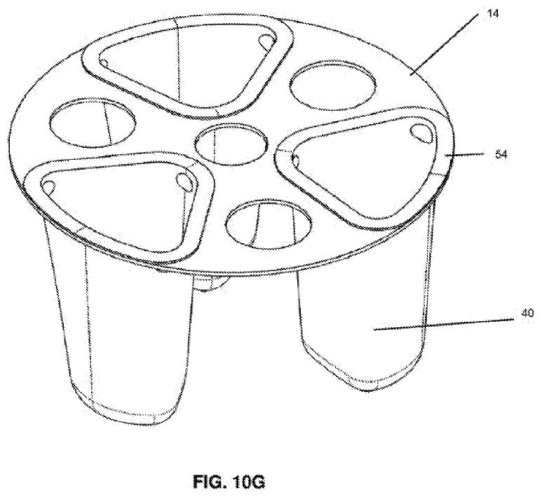

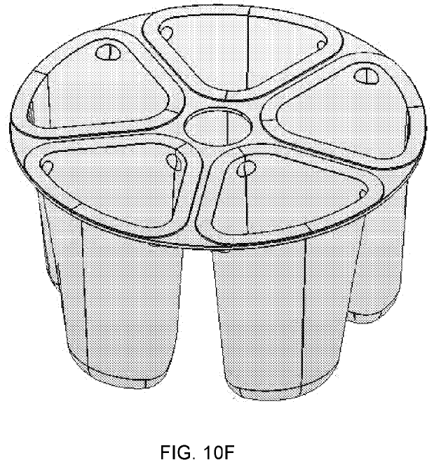

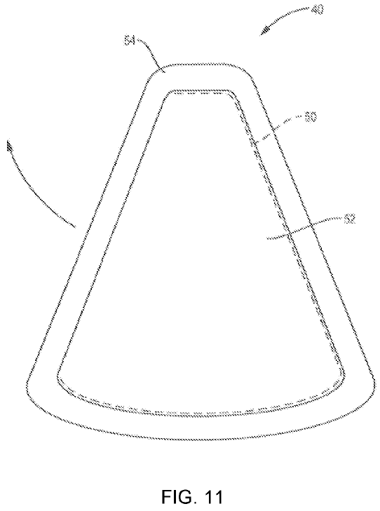

In a particular configuration, the individual wedge-shaped pods or pie-shaped wedge packets (e.g. thermoformed or injection molded plastic wells) are filled with various powdered or concentrated liquid nutrients or beverages and sealed either by hand or an automated system. An inventory of various supplement beverages in filled packets is then available for either manual insertion or via a pick and place type of robot. In a particularly preferred configuration, the wedge-shaped pods suitably have a uniform and substantially flat flange section at the pointy end (e.g. suitably less than about an inch such as about ⅝ of an inch) that engages with the central disk structure as generally shown in FIGS. 10C and 11. In a particular configuration, two opposed notches on the pie-shaped wedge engage with the struts in the disk structure, holding the wedge in place, but also allowing the end user to swap locations of supplements, add or remove supplements, add or remove beverages, based on daily variability/preferences. As discussed above, the pie-shaped wedges may be, inserted into the flat disk or rotor, and held in place by the protrusions, or press fitted into the disk structure having featheredged cavities.

The disposable rotor preferably has an RFID with a unique order identification that corresponds to a purchase order number (or other identifying information) that allows the apparatus to identify the contents or content category of the rotor. This may then be communicated or transmitted to the app for tracking and messaging, which will be discussed further below.

### Packets/Pods of Ingestible Materials

In a particular preferred embodiment, each packet comprises one or more ingestible materials and is nested within the dispensing unit of the portable fluid dispensing apparatus. The packets may each be formed as a wedge, and more specifically, as a pie-shaped wedge. However, the present disclosure is not limited thereto and other packet shapes will be discussed below with reference to the drawings. Each packet comprises at least one protrusion formed as a dot, wart, or similar shape, but optionally three protrusions, to engage with the disk structure of the dispensing unit. In another embodiment, each packet may comprise a single protrusion formed in a ring around the outer of the packet. In particular, once the packets are charged or loaded into the rotor, the rotor sits between a flange of the packet and the protrusion of the packet to provide a secure engagement therebetween. In a more particular embodiment, the distance from the flange to protrusions may be about 2 thousandths of an inch less than the dimensional thickness of the rotor.

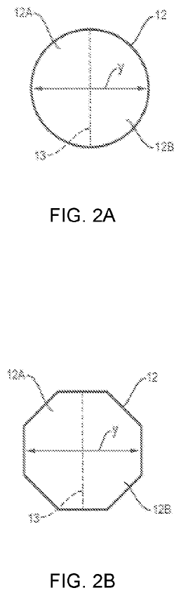

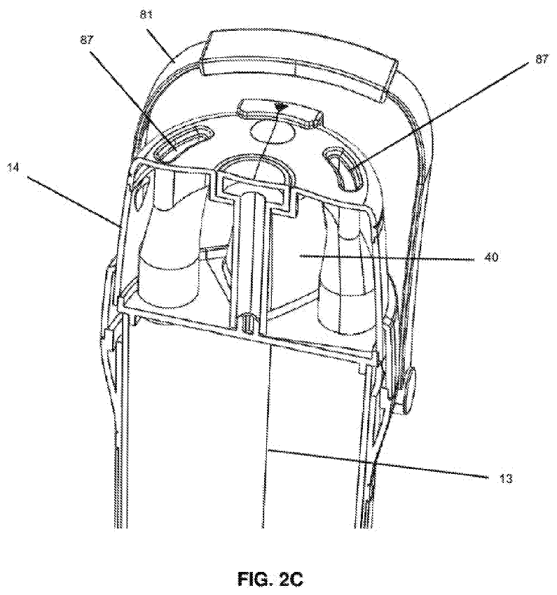

In general, for preferred systems, the rotor unit thickness will be 1) greater than the distance from a pod lower lip (on which the rotor rests) to the bottom edge of the pod protrusion (e.g. dot-like or wart-like feature shown in FIGS. 10A, 10C, and 10D) and 2) less than the distance from a pod lower lip (on which the rotor rests) to the thickest or most extending point (e.g. mid-point) of the pod protrusion (e.g. dot-like or wart-like feature shown in FIGS. 10A, 10C, and 10D). By such arrangement, the rotor thickness sits in part on the lower face of a pod protrusion (e.g. dot-like or wart-like feature shown in FIGS. 10A, 10C, and 10D). Also by such arrangement, the pod lower lip and pod protrusion (e.g. dot-like or wart-like feature shown in FIGS. 10A, 10C, and 10D) can provide an effective press-fit engagement of the rotor.

Each packet may include either visual or tactile indicators which may be color, textual, or shape-coded. Other types of detectable labels may also be used. These labels or indicators provide a notification to a user or app of the content or content category. For example, a packet or group of packets may comprise contacts/dots, a QR code, or an RFID chip enabling the dispensing apparatus to sense the ingestible material that is dispensed at a particular time. The QR code or other label (e.g., lot code, bar code, consumer readable information such as product name, expiration date, or the like) may be applied to either a bottom of the packet, one of the sides of the packet, or on the lidstock of the packet using ink that is safe for direct and indirect contact with ingestible materials. Alternately, the packet may be labeled on both the lidstock and the bottom or dome thereof (e.g., the bottom thereof may be dome-shaped).

The packets or pods are formed to contain about 1 to 30 or more grams of ingestible materials and preferably, up to about 8, 10 or 12 grams, particularly 8 or 12 grams. As described above, the ingestible materials may be of powder form and/or liquid (e.g., concentrated liquid nutrient or supplement). The longest dimension of each packet is less than about 6, 5, 4, or 3 inches but is also able to be less than 2 or 1.5 inches. Additionally, the packets may be formed by a variety of methods including thermoformed or may be injection molded. In the embodiment of being thermoformed, the average draft angle from a flange to a bottom of the packet (either flat or dome shaped) is about 5 degrees. However, the draft angle curves/rounds off near the bottom of the packet to allow an even flow of material around the corner at the bottom of the packet during pod fabrication and a maximum cubic volume for each packet.

Another component of the packets is the lidstock which provides access to the one or more ingestible materials. The lidstock may be formed to be non-peelable, peelable, piercable, or scored on at least one location. For example, when the lidstock scored on two sides, as shown in FIG. 11, the retained side (e.g., the side without a perforation or score) is on a leading edge to prevent the material from blocking the rotation of the rotor when the packet is punctured or opened to dispense the ingestible materials (e.g., prevent inhibiting rotation of the disk unit). In other embodiments, the lidstock may be scored on one side or alternatively, through a center thereof. In yet another embodiment, the lidstock may only be partially scored with a score radiating from a center of the lidstock.

The lidding or lidstock and the packets may be made from substantially the same material to facilitate recycling. For example, the lidstock and packets may be made from PET, PLA, HIPS, biodegradable polymer, biocompostable polymer, a dissolvable material, or the like. Preferably, the lidstock is comprised of layers to allow reduction of strength, preserve barrier properties, and facilitate recyclability. For example, the layers may include a strength layer, a tie layer, a barrier layer, and a seal. When the lidstock is laser scored, the barrier layer remains intact (is not scored) to prevent any contamination, moisture, air, or the like from entering the packet. The barrier layer may be weak enough to be easily punctured when the lidstock is punctured at the scored sections.

In a particular embodiment, the packets are stored and provided to a user in a packaging unit. The packaging unit may be a sleeve, box, bag, or similar element capable of storing the packets without puncturing through the lidstock. For example, the packets may be stored within the packaging unit in alternating orientations or directions (e.g., flange to flange and not top to bottom) or may be nested in an abutting manner. Any number of packets may be stored in each packaging unit, for example, 6, 10, and 14. In one configuration, the packaging unit accommodates 7 or 14 packets to allow weekly packaging options. In another embodiment, the packets are stored in a loaded state within the packaging unit. In other words, the packaging unit accommodates the packets nested within the rotor. This packaging unit will be further described below in reference to the drawings. In another alternate embodiment, the packaging unit may be wrapped with a barrier film to enhance barrier properties.

### Time Optimized Formulas

Supplementation methods also are provided that take into account time of day to optimize the absorption, effects, and ultimately performance of the product, accentuating the positive aspects of supplementation and diminishing negative effects. This can yield a materially better result than when a supplement program is simplified, where many compromises are made including once a day administration to ensure adequate compliance. This can create an additional dimension for a formula—not just which ingredients and how much of each ingredient, but also exactly when during the day each ingredient in a potentially valuable formula is administered and with what other food or supplements.

Examples of the benefits of this method include:

Optimizing energy by giving stimulatory ingredients according to wake/sleep times and circadian highs and lows;

Optimizing sleep onset and duration by giving depressant nutrients and ingredients (Mg, tryptophan, melatonin, etc.) before bedtime;

Targeting fat soluble vitamins for mealtimes, when fats are more likely to be ingested;

Divided dosing of nutrients with short half-lives like vitamin C, ensuring more area under the pharmacokinetic curve for a given amount of nutrient ingested in a 24 hour period;

Giving nutrients that act best during sleep to just before sleep;

Staggering nutrients that compete for binding sites or absorption mechanisms or in some other way;

Co-administration of nutrients that assist each other, including co-factors (e.g., calcium requires vitamin D for optimal absorption, iron is best absorbed in presence of vitamin C);

Reducing processing load on kidneys, liver and at the cellular level from taking a high dose of pills/nutrients at once.

### Time-Optimized Supplementation App

The present systems and apparatus can benefit from use of electronics, algorithms, databases, third party data, global positioning systems (GPS), communications systems such as wireless telephony, short message service (SMS), email, connected smart watches, fitness trackers, and native functionality of phones (e.g., gyroscope, temperature sensor, motion sensor, camera, etc.) to utilize a specially designed and programmed application (app) that communicates with the hydration system via Bluetooth® or other type of connection. The app may output an active image of the portable fluid dispensing apparatus and is capable to, for example:
1) Customize the daily supplement and hydration program for an individual user, based upon the user's gender, age, height and weight, ethnicity, reported general level of activity including training, daily pattern of other beverages ingested, fitness goals, weight goals, medical concerns, physical restrictions, allergies and dietary restrictions, and flavor preferences and aversions.
2) Each day's routine may be modified by a log of the day's activity, sensed level of the day's activity (via step counter, phone inputs, etc.), current presence/activity at a gym, presence at work, scheduled meetings, current illness such as diarrhea, common cold, flu, etc.
3) Assist with hydration and supplementation adherence by outputting visible reminders (e.g., LED on flask, on dispensing head, on flask screen, on mobile device screen, fitness trackers, smart watches, and the like via messages such as SMS and email) and auditory reminders (e.g., on flask screen, via flask speaker, dispensing head, on app on mobile) that may be optimized based on other inputs (e.g., Apple Watch®, Fitbit®, iPhone® steps tracker, weather apps, GPS signals, gyroscope motion sensor, or the like)
4) Identify and geolocate public water dispenser stations, water fountains, or bathrooms based on current fill level of water bottle, current location, current navigation route (when on foot), and presence of public water stations both in the immediate vicinity and nearby (e.g., “last water for 2 miles”). This information may be stored in a database for future use. In another words, this and other algorithms may be a learning algorithm that captures data from users to improve overall accuracy. For example, a user may be alerted via text, via chime or other audio output on phone, via a unique phone vibration, via a phone call, via light signal on flask, via vibration of flask, via audible chime on flask, or the like. Water refill locations may be crowdsourced to 1) add a new location via the app, pushing a button on the flask, or gesturing with the flask (e.g., tapping flask), 2) rate the location for coldness, flavor of the water, cleanliness of the fountain, presence of bottle refill station. Users may also access the app to provide feedback regarding the station information. For example, a user may provide information regarding disabled or closed refill stations. This information may then be accessible by other users of the app, for example, when the information is entered as publicly accessible information versus private information.
5) Provide daily, weekly, monthly graphical report cards of 1) actual hydration vs. optimal or recommended nutrition, 2) actual supplementation vs. optimal or recommended hydration. These reports, or sub-components thereof, or inspirational messages/points may be distributed via email, text, app, or on screen computer or mobile device, as determined by the user. The application may also provide an informative, inspirational and light hearted profile of an individual nutrient (such as Vitamin C) to maintain motivation and adherence to the program for those users interested in receiving further information. This report, including the educational material regarding the ingredient, will be sharable on social media or through the app.
6) Serve as a central repository for daily health tracking information, such as: daily weight, daily steps taken, macro nutrient counting, calories burned, Weight Watchers® points consumed, actual fitness vs. fitness goal, hours of screen time (e.g., time spent using mobile device), hours spent talking on phone, messages received vs. messages replied to, actual diet vs. diet goal, daily physical and mental wellness ratings, daily journaling, daily goal setting, daily gratitude exercise, daily blood glucose meter values, hemoglobin Ale (HBA1C) values, etc. This app will synchronize with phones, watches, fitness trackers, medical information systems, daily glucose tracking systems, etc. and will provide comprehensive, printable, emailable health reports via email and on screen/in-app viewing.
7) Locating the flask system when misplaced. It will allow a directional map input, as well as flashing and progressively louder beeping upon being signaled from the app.
8) Capture a QR code of a rotor or individual packets to record rotor or pod content. For example, even if the packets within the rotor have been replaced or switched, the QR code may provide a user with the information of the original content based on stored data.
9) Correlate sensed environmental factors with online accessed information such as temperature and humidity.

### Storage Unit

The flask system may be desirably cleaned and stored for charging periodically, for example, daily or other schedule. It is also possible that some supplements will be taken in pill form upon waking, at bedtime, or other preferred time.

To provide an optimized user experience, the system may utilize a multipurpose charging/storage stand that charges the battery pack (e.g. NiCd or lithium battery) during scheduled times (e.g., overnight). Alternately, the flask may be charged via inductive charging, pogo pins on a base unit, or a wired cord. The flask may further comprise a bidirectional USB-C port to allow the flask to be charged from the wall or to charge a mobile device from the flask. Generally, the flask will only require rinsing, but the dispensing head desirably may include further cleaning. The storage unit suitably may comprise dedicated brushes and a soap or other cleansing material optimized for cleaning the dispensing head as well as the flask. These brushes will be preferably out of sight, and preferably there will be an ultraviolet (UV) light to sterilize the brushes and dispensing head as well as a small fan that dries the dispensing head and brushes.

The storage unit will suitably have storage for optional the swappable components, again preferably tucked out of the way for a neat clean modem look. In a preferred embodiment, there will be multiple drawers (e.g., four drawers), with front plates that can be flipped from a.m. to p.m. or removed to indicate an empty drawer, and a sliding indicator to indicate number of supplements indicated for a.m. and p.m. doses for items like Rx products, gel caps, etc. This storage unit will be available in white and black and optimized to occupy minimal counter space.

### Other Features

As also discussed, the present apparatus and systems may optionally comprise further components, modules and functionality. For instance, the base component suitably may be further configured to supply fluids or other ingestible materials to the vessel component to be dispensed therefrom to a user of the apparatus. In particular, as an additional component, or as a combination of other components such as a blending unit (e.g., a mixer) or temperature control unit, a module may be employed that supplies additional fluids or other ingestibles to the vessel or flask component, for example one or more of a flavoring including sweetener, protein, electrolyte and the like, and more particularly one or more of a monk fruit non-caloric sweetener, monk fruit erythritol blend, syrup/sugar solution, honey, vitamin C booster, liquid protein isolate, electrolytes, pre-work out mix, post-work out, liquid creamer for instant tea or coffee.

As another embodiment, the packets may contain an infant formula and the apparatus may comprise a nipple capable of being stored within the bottle to administer the blended formula to an infant. In this configuration, water filled in the vessel component may be sterilized using a UV-C light provided within the apparatus. A heating element in the base component may be used to heat the formula to an optimal temperature (e.g., 95° F.). The blender of the base component may be used to mix the formula with the sterilized, heated water. The base component may also comprise a compartment for storing the nipple and may comprise a UV-C light to also sterilize the nipple. This embodiment will be described in further detail below with reference to the figures.

Referring now to the various figures of the Drawings, FIGS. 1A-1D shows a suitable portable dispensing apparatus 10 that includes vessel component 12, dispenser/dispensing component 14 and base component 16. In particular, FIGS. 1C and 1D provide a cross-sectional view of the dispensing apparatus and components thereof.

As discussed, base component 16 may comprise various functionality, including for instance a temperature control unit 18 which may provide heating and/or cooling as desired of fluid residing within vessel component 12. As discussed, temperature control unit 18 is preferably positioned adjacent (e.g., attached below) to vessel component 12 and may be in direct communication with a fluid position within the vessel component 12 and for example may provide a fluidly sealing bottom face of vessel component 12.

Base component 16 may comprise additional functionality such as a mixing unit 20 to admix or blend materials (e.g. fluid and one or more ingestible materials) within vessel component 12, and a storage unit 22 (e.g., pill box) to retain any various desired materials for example one or more therapeutic agents or supplements that may be ingested by a user without admixing with fluid in vessel component 12. The vessel component 12 may also comprise a power unit 23 which may be, for instance, an electric connection or a housed battery.

Alternatively, as shown in FIG. 1E, the base component 16 may be indicative of the base of the vessel component 12 with the blender 20 mounted within the vessel component 12, thereby eliminating the additional components attached below the vessel components and decreasing the overall size of the dispensing apparatus.

Dispensing apparatus 10 may be configured in a variety of arrangements, as shown in FIG. 1F. For example, as shown, the vessel component may include a transparent window 70 which allows a user to visually determine a fluid level within the vessel. The vessel component 12 is also shown to be formed of an opaque material. Additionally, the dispenser component is typically shown with a covering component 72. Alternately, the dispenser component may have a transparent window 74 providing a visual indication of the loaded packets therein. The vessel component also includes an optional blending button 76 to manually initiate the blending of the ingestible material with the fluid. The blending function may also be automatically engaged in response to detecting the dispensing of a packet or in response to detecting a motion or movement of the apparatus. A power button 78 may also be optionally provided to initiate the apparatus and components therein.

FIGS. 1G-1H illustrate a detailed view of the dispenser component of the apparatus. In particular, the dispenser component 14 comprises a lower member 14a that is secured to the flask via threads or similar attachment, wherein the lower member 14a has a central, up-facing pivot point 14b that allows the rotor to spin radially, and a seal 14c is provided between the rotor and the dispensing head. A top member 14d engages with the disposable rotor and pods 40 placed within the dispensing head. Additionally, the lower member 14a comprises a cam 14e and the rotor comprises a cam 14f corresponding thereto, both described below in regards to rotation of the dispenser component.

Particularly, when the dispenser component is rotated to position a selected pod to a dispensing position, a seal between the pod and the top of the cavity of the rotor is opened and sealed by a dog clutch assembly, or similar driven face clutch assembly. This clutch assembly allows for rotation in one direction while inhibiting rotation in an opposite direction. The assembly includes a cam (e.g., dog face cam or the like) on a dispenser side and a cam (e.g., dog face cam or the like) on a pod holder side. The cam on the dispenser side is fixed to a top surface of the rotor and aligned with a puncturing position and the cam on the pod holder side is aligned with the center line of the pods and is rotationally fixed to the rotor. Notably, the cam on the pod holder side is capable of moving in an axial direction into the rotor about 0.04 to 0.24 inches. This cam may be fixed to or integral with the rotor. Alternately, this cam may be a separate component rotationally coupled to the center shaft.

Further, as the dispenser component is rotated by a user, both cams are held in contact by a compression spring 14g of required spring constant to provide sufficient sealing, provide resistant to rotate without user manipulation, and provide a haptic that indicates to the user that a single, full rotation of the dispenser unit has been completed. The range of advancing a single pod location is based on the number of cavities within the rotor (e.g., varies between different rotor configurations discussed further below). For example, a rotor comprising five cavities in which pods are nested, has a rotation of 72° between pods, a rotor comprising four cavities with pods nested therein, has a rotation of 90° between pods, and a rotor comprising three cavities with pods nested therein, has a rotation of 120° between pods. Accordingly, to be accommodated within the cavities, an inwardly pointing corner of each pod when nested within the cavity may be about a 72° corner.

From a sealed or closed position, as the dispenser component is rotated, the cam begins to separate as the faces of the cams move up the face ramps of the cams. One the rotor is fully advance to the next pod location and the face ramp ends, the dispenser component is pushed down into a sealing position by the spring and remains this engaged, dynamically static position until the next rotation.

The dispensing apparatus 10 may also include varying cross-sections such as substantially circular or oval as generally depicted in FIG. 2A or polygonal as shown in FIG. 2B. Similarly, for instance, base component may comprise units 18, 20, 22, 23 in a different arrangement than as shown in FIG. 1A, or other functionalities could be provided by greater or fewer number of distinct units. Thus, a single unit could be utilized to provide for each of temperature control, storage of therapeutics and power, or separate units could be employed for heating and cooling respectively of fluid within vessel component 12. The dispensing apparatus 10 suitably may vary widely in dimensions, for example, height q (FIG. 1A) may be from about 6 to 24 or 30 or more inches, more typically from about 6, 8, 10, 12, 14, 16, 18, 20, 22, 24 or more inches. Cross-sectional dimension y (FIGS. 2A and 2B) of apparatus 10 may be substantially uniform for the height of apparatus 10, or the cross-section dimension y may vary through the height of apparatus 10. Suitably, cross-sectional dimension y may be from about 2 to 12 inches, more typically about 3, 4, 5, 6, 7, or 8 to about 10, 12, 14 or 16 inches.

As discussed, a divided vessel component may be utilized to provide for storage and use of multiple distinct fluids, for instance as shown in FIGS. 2A and 2B, where a vessel component 12 may comprise multiple fluid storage chambers 12A, 12B that are defined in part by vessel chamber wall 13. The wall 13 (shown as a dashed line in FIGS. 2A and 2B) may be a metal (e.g. stainless steel) or plastic wall that extends the vertical height of vessel or flask component and optionally may have a retractable portion at a lower end to provide an opening as desired and thereby fluidly join the separate chambers 12A and 12B as desired. FIGS. 2C and 2D illustrate how the top of the apparatus may include, for example, three distinct mouth pieces in communication with three different fluid chambers.

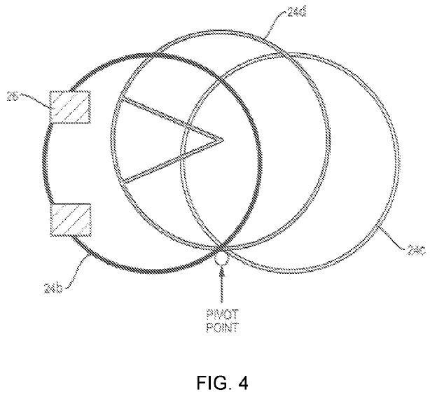

FIG. 3A shows an exemplary apparatus 10 that includes dispenser component or dispensing unit 14 with a fluid output unit 24 that includes mouthpiece or drinking tube 26. The output feed unit 24 is capable of pivoting as depicted from closed or storage positions 24a and 24b, to a drinking position 24c for dispensing fluid (optionally containing one or more ingestible materials) to a user, to dispensing position 24d for rapid emptying of fluid from the apparatus 10. FIG. 4 further shows that output feed unit 24 in several positions 24b, 24c and 24d.

FIG. 3A also depicts a configuration where the dispenser component 14 is laterally offset with respect to the adjoining vessel component 12, e.g. the center vertical axis 14′ of the dispenser component 14 and center vertical axis 12′ of the vessel component 12 are offset or separated by distance b as shown in FIG. 3A. This offset or distance b provides for placement of fluid output unit 24 as shown in FIG. 3A. In other words, the rotation of the dispenser component 14 allows for the fluid output unit 24 to be rotated into a drinking position 24c. Distance b may suitably vary widely, for instance distance b suitably may be from about 2 to 100 mm, more typically 10 to 60 mm, or other values.

Additionally, FIGS. 3B-3D illustrate alternate rotations of the dispenser component 14 relative to the vessel component 14. For example, FIG. 3B illustrates a rotation of the dispenser component via a pin 82 while FIG. 3C illustrates the rotation via a bore 84. FIG. 3D illustrates another configuration having a concentric rotation. In particular, in this configuration, the drinking tube may extend through a center of the vessel component. The top of the dispenser component 14 may comprise a drinking tube housing 86 that accommodates the drinking end of the tube when in use. The rotation of the tube from a storage state to an in-use state may be actuated by a button 88. In this configuration, the dispenser component 14 does not require rotation to use the drinking tube or activate the dispensing of the ingestible materials.

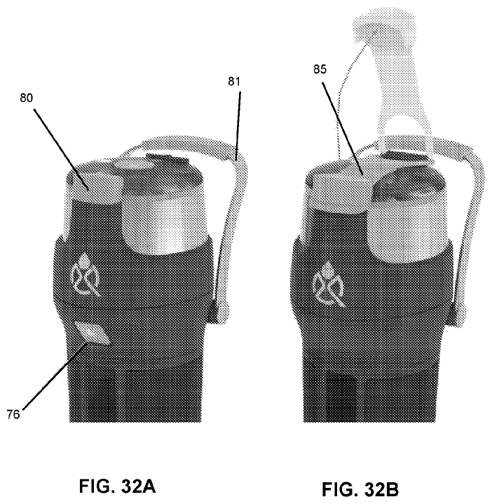

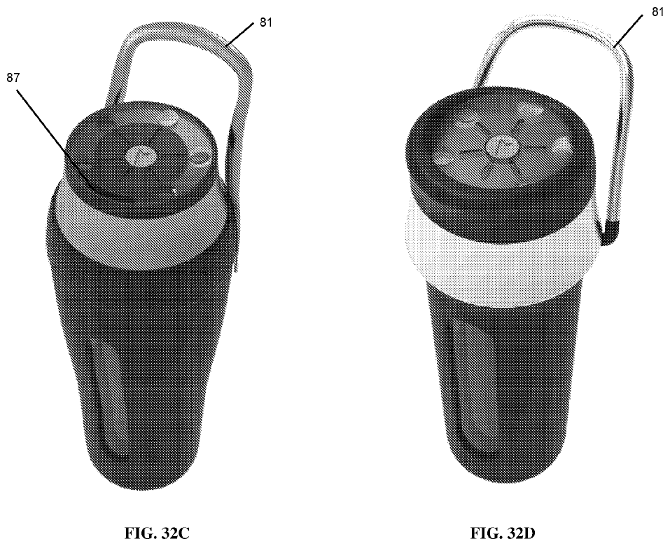

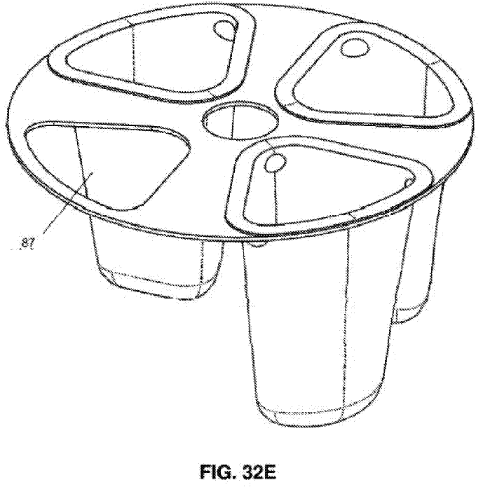

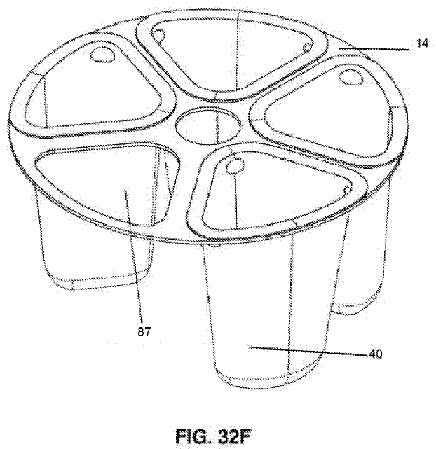

In a preferred configuration, the drinking tube may be eliminated and a drinking path may be provided through the dispenser component as illustratively shown in FIG. 1F and FIGS. 32A-32D. For example, in such a configuration, the drinking path 87 may extend through the dispenser component and a mouth piece 80 may extend out the top of the component adjacent but separated from to the rotor housing, where the drinking path is external to the path of rotation of the packets. A cavity of a rotor unit may also function as part of the drinking path. This configuration may additionally comprise a handle 81 rotatably attached to the outside of the vessel component. Alternately, the handle may be formed as a lever attached to the outside of the vessel component. The rotation of the handle or lever may actuate a striker within the dispenser component to release the ingestible materials into the vessel component, which will be described further below. Notably, FIGS. 32A-32B also illustrates an optional cap 85 lifted to open access to the mouth piece 80 of the drinking path.

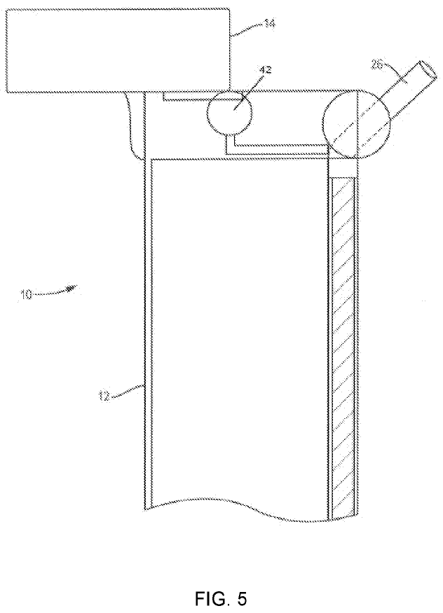

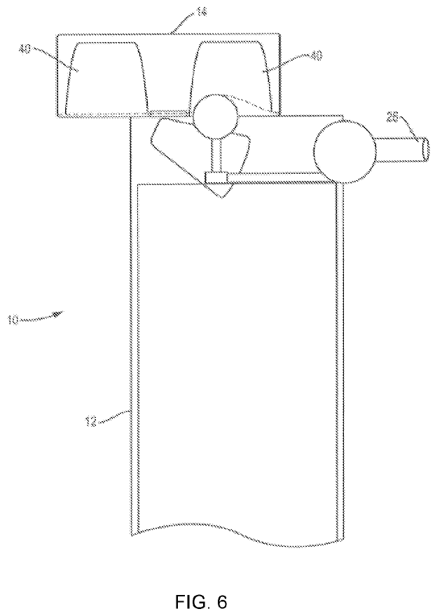

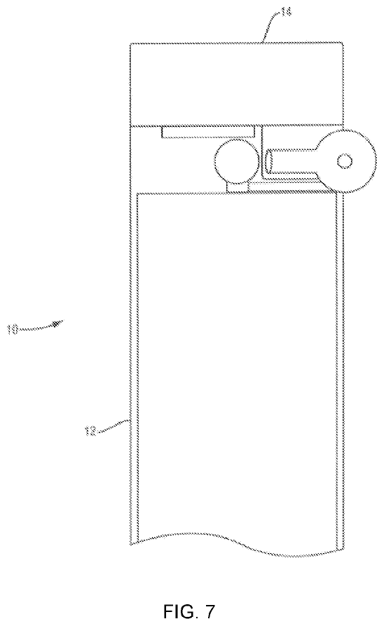

FIGS. 5-7 show further the dispensing apparatus 10 that includes the flask or vessel component 12, dispenser or rotor component 14 and fluid output unit with drinking tube 26. First, FIG. 5 illustrates the rotation of the dispenser component 14. FIG. 6 then depicts packaged ingestible materials 40 nested within dispenser component 14. For example, FIG. 6 illustrates the rotation of the drinking tube 26 causing the striker 42 to push up against the lidstock of the packet or pod 40, in turn, puncturing through the lidstock to release and dispense the ingestible material into the vessel component. FIG. 7 illustrates the drinking tube in a storage position with the dispenser component 14 rotated back in line with the vessel component 12.

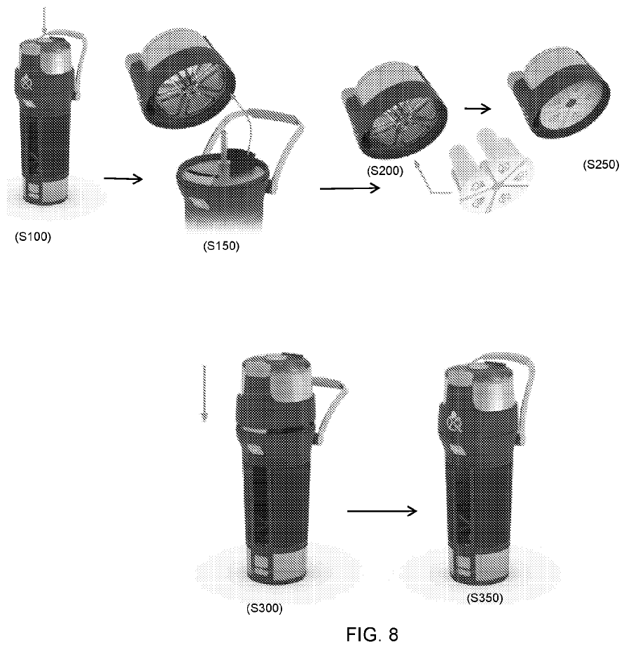

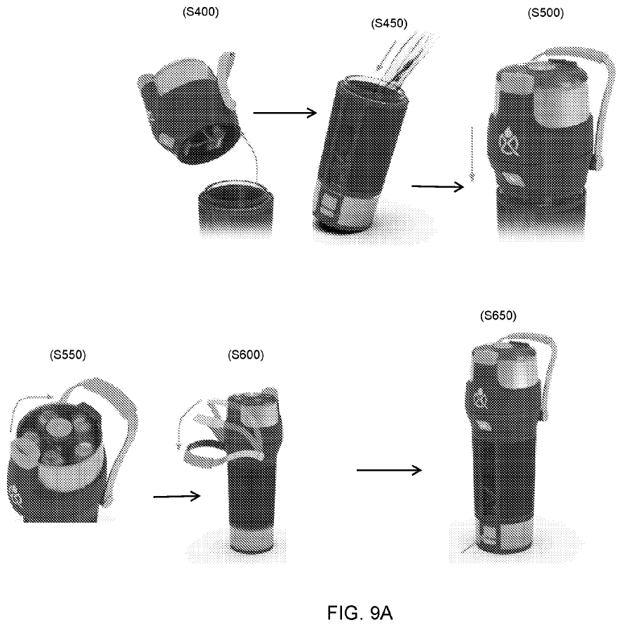

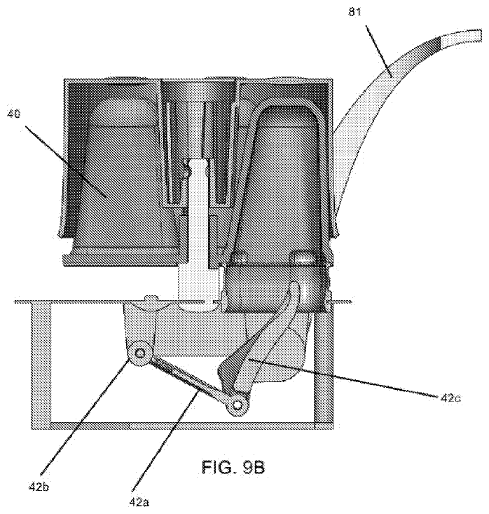

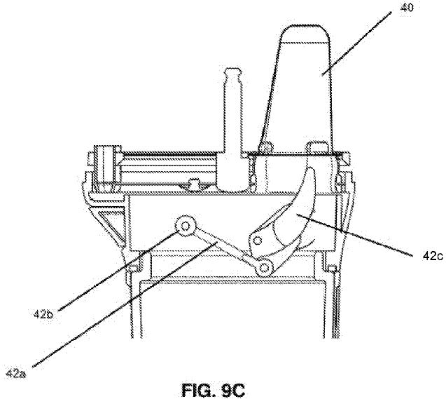

FIG. 8 illustrates the preferred method of loading or charging the portable dispensing apparatus as described above with a drinking path through the dispenser component (no drinking straw). Notably, a cavity of the rotor may be part of the drinking path 87 to provide a more compact dispensing apparatus, as shown in FIGS. 32E-32F. In an initial step, S100, a button disposed at the top of the dispenser component is engaged or pushed to release the seal between a disk structure of the dispenser component and a dispensing portion thereof to allow for cartridge or rotor loading. In S150, the dispenser component is lifted off and separated from the vessel component. This step also illustrates the central bore onto which the dispenser component is fitted to allow for free rotation. Additionally, this step illustrates the dispensing station, as previously described in one configuration. For example, a desired dispensing pod is rotated to the dispensing station and engagement of the dispensing (by rotation of a handle, drinking tube, or other described method) allows for opening of the pod disposed at the dispensing station (where the door described with S550 of FIG. 9A is located). In an alternate configuration, the dispenser component may remain coupled to the vessel component via a tether or similar attachment.

Further, in S200, the rotor, with pods nested therein, is aligned with the dispenser unit with the bottom end of the pods being inserted first (S250) into the disk structure of dispenser component such that the lidstock is exposed. In S300, the loaded or charged dispenser component is aligned back onto the vessel component and pressed down (S350) to lock the components together.

FIG. 9A illustrates a method of making a beverage with a loaded dispenser component. In step S400, the entire dispenser component is separated from the vessel component (e.g., unthreaded or unscrewed therefrom) to fill the vessel component with a desired fluid S450 (e.g., milk, frothed milk, carbonated water, dairy-free milk, etc.). The dispenser component is then reattached to the vessel component S500 (e.g., by a threaded connection). The rotor housing 83 is rotated to dispose a desired pod or packet in a dispensing position S550 (e.g., rotate until the selected pod reaches a dispensing station) and then the handle 82 is lowered (or otherwise rotated) to dispense the ingestion materials within the pod into the vessel component S600. In step S650, a button may be engaged to activate a blender mounted within the vessel component to blend the ingestible materials with the fluid. The beverage is then ready for consumption.

As a further explanation of S550 and as illustrated in FIGS. 9B-9D, the dispenser component 14 is disposed within a chamber of the dispensing apparatus and the chamber includes a retractable door unit to admit the dispensing unit to the chamber. The apparatus (e.g., striker 42) facilitates opening of a packet 40 and includes a lever 42a, a cam 42b, and a hammer 42c. Particularly, the apparatus comprises a door that opens in a dispense mode and closes in a drink, storage, or blend mode. The door also closes with a seal, preferably actuated by a spring that prevents water from entering the storage chamber of the dispensing unit. The handle 81 of the configuration activates the opening of the door and rotation of the striker against the packet to release the ingestible materials.

FIGS. 10A-11 provide a detailed drawing of the packets and the packets nested within the rotor which is, in turn, nested within the dispenser component. As shown in FIG. 10A, each pod 40, may include a flange 54 at a lidstock end thereof and when inserted into the rotor, the rotor is seated on top of the flange. Each pod also comprises at least one protrusion 11, described in further detail below. Additionally, as shown in FIG. 10C-10D, each packet may include a label 90 indicative of content or content category, and a more descriptive, longer format label on the lidstock side.

FIG. 10B shows a dispenser component 14 configured in a rotor arrangement with multiple nesting chambers 34 or cavities. As further shown in FIG. 10E, the dispenser component 14 suitably releasably engage one or more pods 40 of ingestible materials that can be fed as desired into the vessel component 12. FIGS. 10F-10G show a view of the pods nested within the dispenser or rotor component. In particular, FIG. 10F illustrates a rotor with five cavities loaded with pods and FIG. 10G illustrates a rotor with three cavities loaded with pods.

Rotor component 14 suitably contains a label identifying for example the ingestible materials within the pod units 40 and/or the specific person that the rotor has been produced for, or the group of persons (e.g. woman in specified stage of pregnancy, gender, endurance athlete, person over 70 years or age) that the rotor unit and contents thereof are designed to be particularly useful or appropriate for. The label may be separate from the rotor or more preferably is affixed or otherwise directly attached or integrated on or into the rotor unit 14.

FIG. 11 depicts a preferred packaging or pod unit 40 for retaining ingestibles that can be loaded into a dispenser component 14 or more specifically, nested into a rotor arrangement of the dispenser component. As depicted in FIG. 11, unit 40 suitably comprises scored opening lines in top (e.g. plastic lidstock, foil lidstock, or the like) portion 52 with a front flange 54. That flange 54 can facilitate releasable secure engagement within a rotor or other dispensing unit 14.

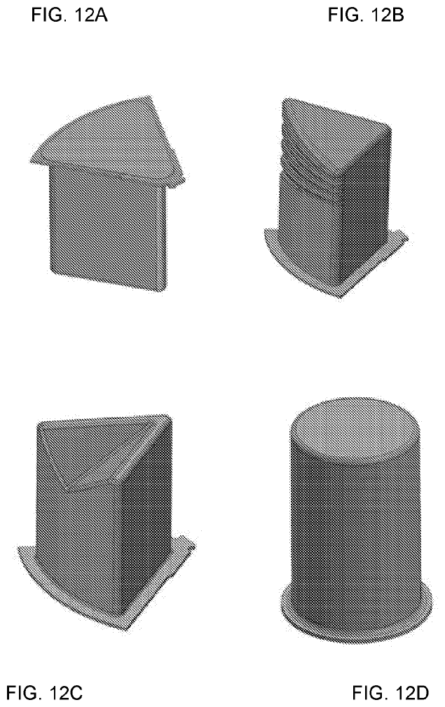

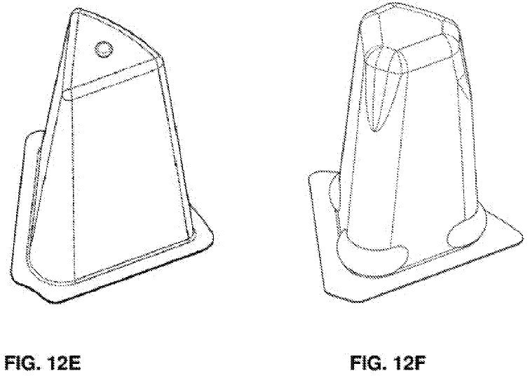

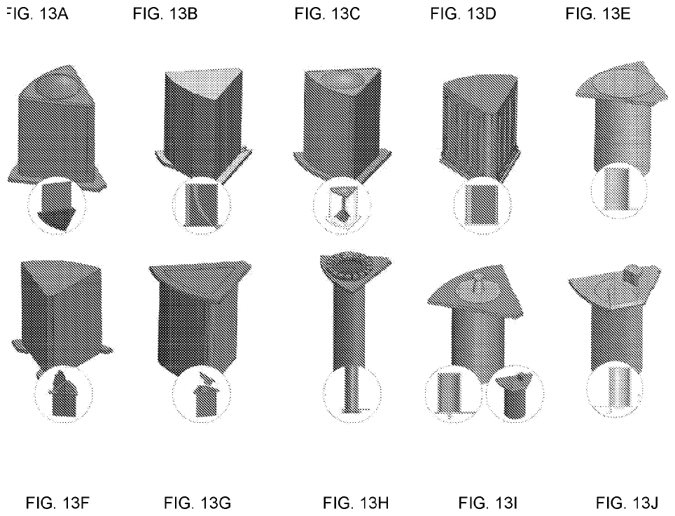

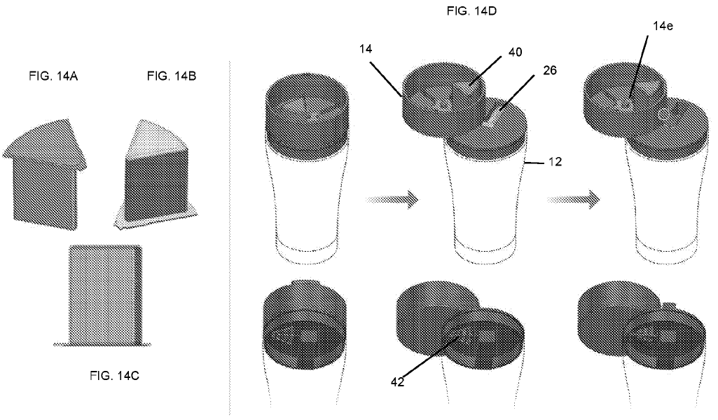

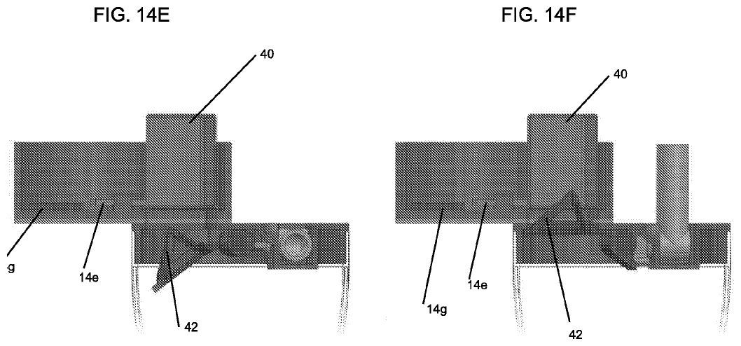

FIGS. 12A-12F and FIGS. 13A-13J illustrate a plurality of alternate configurations of the packets. In particular, FIGS. 12A-12F illustrate six packet configurations of thermoformed packets and FIGS. 13A-13J illustrate ten packet configurations of injection molded packets. For examples, the figures show variable shapes of the packets such as three-sided, four-sided, cylindrical, and combinations thereof. The use of these packet configuration with a portable dispensing apparatus will be described in reference to FIGS. 14A-31D.

FIGS. 14A-14C illustrate a thermoformed packet having a substantially wedge shape. In particular, the packet is formed as a pie-shaped wedge have three sides, a bottom which is substantially flat, and a lidstock side. As shown, the packet also includes a flange formed at the lidstock side to engage with the disk structure of the dispenser component. The lidstock in this configuration may be piercable. FIG. 14D illustrates the dispensing apparatus in storage, pod loaded, and pod puncture configurations. In this configuration, the dispenser component 14 is rotated to be offset from the vessel component 12 to reveal a folded drinking tube 26. As shown in FIGS. 14E-14F, in response to rotating the drinking tube into a drinking position, a striker 42 mechanically coupled thereto, is lifted up towards the rotor and punctures through the lidstock of the packet disposed at the dispensing station. The frame structure of the striker 42 allows the ingestible materials to release down into the vessel component through the openings of the striker.

FIGS. 15A-15C illustrate a thermoformed packet having substantially the same shape as that of FIGS. 14A-14C. However, in this configuration, the lidstock may be peelable with two sides being scored. Additionally, in this configuration, the striker operation varies to dispense the ingestible materials. As shown in FIG. 15D, the striker 42 has a mesh structure and rotates in a fixed position and is not lifted up towards the packet lidstock in response to the drinking straw rotation. In particular, as shown in FIGS. 15E-15F, the rotation of the drinking straw, rotates the striker such that the striker peels the lidstock of the packet open to dispense the ingestible materials. Since only two sides of the lidstock may be scored, the lidstock remains attached to the packet, thus preventing the lidstock from falling into the fluid within the vessel component.

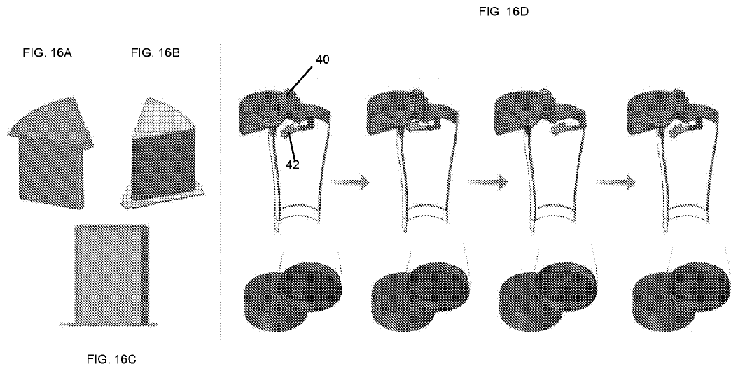

FIGS. 16A-16C illustration a thermoformed packet having substantially the same shape as that of FIGS. 14A-14C and FIGS. 15A-15C. In this configuration, as shown in FIG. 16D, the striker 42 is formed as needle attached to an arm is provided. For example, the needle is loaded and tilted upward toward the packet to puncture through the lidstock. The arm of the needle may be rotated away from the packet 40 to reload and then rotated back and tilted up to be again in a loaded position.

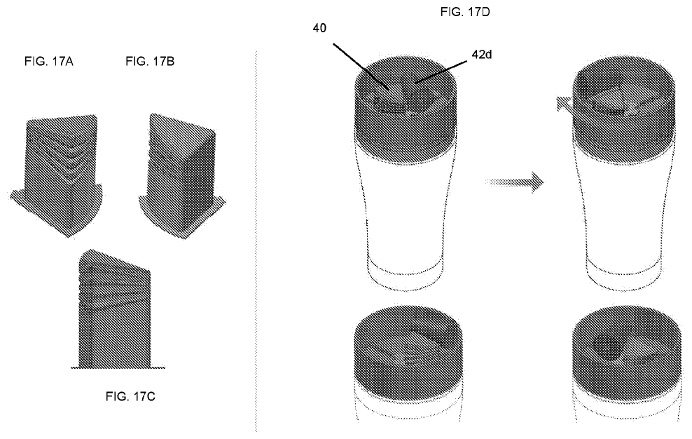

FIGS. 17A-17C illustrate a thermoformed packet having a substantially wedge shape in which a bottom portion of the packet is flexible. For example, one side surface of the wedge shaped packet may include a bottom portion formed as an accordion. The dispensing of the ingestible materials, in this configuration, may omit a drinking straw as an actuating component. Instead, as shown in FIG. 17D, a roller 42d may be disposed adjacent to the pod 40 within the dispenser component. In response to a rotation of the entire dispenser component, the roller is pushed over the bottom of the packet to compress the accordion portion. The pressure from the compression causes the lidstock of the packet to open and dispense the ingestible material into the vessel component.

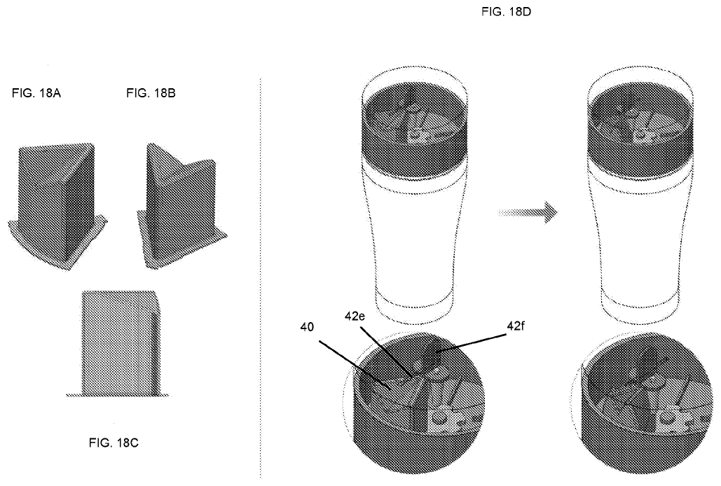

FIGS. 18A-18C illustrates a thermoformed packet having a concave wedge portion formed on a bottom surface thereof. In this configuration, as shown in FIG. 18D, the striker 42 is formed as an extending plate 42e, 43f from a shaft engaged with a cam 14e at a center of the dispenser component. To activate the dispensing of the ingestible materials, the dispenser component is rotated which rotates the cam and pushes the shaft and cam against the packet causing collapse of the concave portion. The pressure of the collapse thus causes the lidstock of the packet to open and dispense the ingestible material into the vessel component.

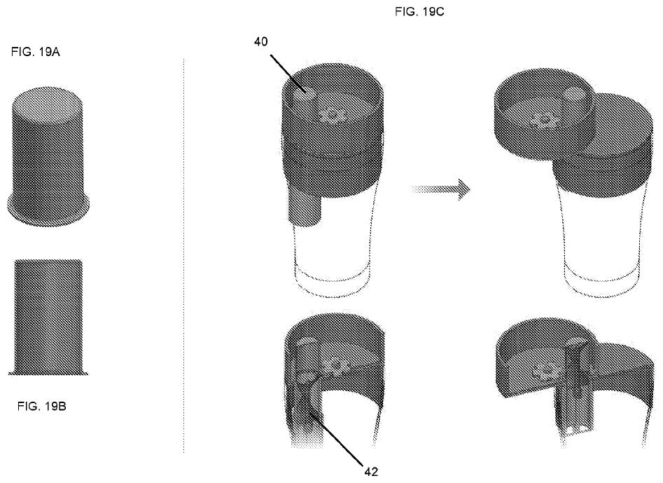

FIGS. 19A-19B illustrate a thermoformed packet formed as cylindrical shape having a flange. In this configuration, as shown in FIG. 19C, the dispenser component is rotated to be offset from the vessel component for activating the dispensing of the ingestible materials. In particular, the striker 42 may be formed as a bore disposed below the rotor. When the dispenser component is rotated, the bore 42 is pushed up through the screw-shaped bore to release the ingestible materials into the vessel component. Alternatively, as shown in FIG. 20, the striker may be a cone shaped bore 42 that is pushed up through the lidstock of the packet upon rotation of the dispenser component.

FIGS. 21A-21C illustrate a thermoformed packet formed as a cylindrical shape having a flange. However, in this configuration, the bore striker 40a may be integrated with the packet itself. The bore striker 40a may be coupled with the bottom of the packet. The end of the bore striker and the bottom of the packet may extend beyond the overall packet length. As shown in FIG. 21D, to activate the bore and dispense the ingestible materials, the end of the bore striker may be pushed down into the packet to pierce through the lidstock. The protruding end of the bore striker may be engaged via a button disposed on top of the dispenser component.

FIGS. 22A-22C illustrate an injection molded packet having a substantially wedge shape. In this configuration, a bottom of the wedge shaped-packet has a dome structure (e.g., a dome-shaped protrusion extending from the bottom surface). Additionally, a lidstock side of the packet is concave protruding up into the packet. The concave shape may be substantially wedge-shaped. The dome shape of the bottom surface may correspond in position to the protrusion of the concave portion into the packet. FIG. 22D illustrates the loading of the pod into the dispenser component and rotation of the dispenser component to be offset from the vessel component. Then, to open the lidstock of the packet, the lidstock is peeled by rotation from the packet.

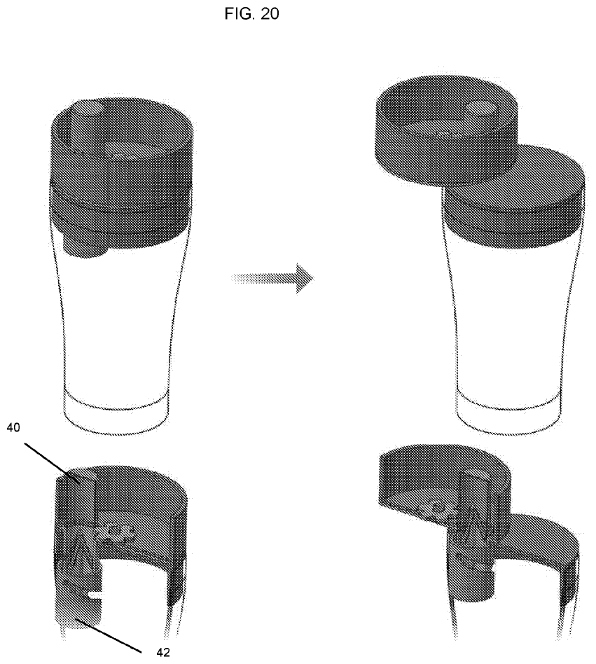

FIGS. 23A-23C illustrate an injection molded packet have a substantially wedge shape. One side of the wedge shape may be formed in three sections (e.g., not rounded) and the lidstock side of the pack includes a hinged lid structure. In particular, the lidstock 40b of the packet may be tethered 40c to the flange of the packet. A protruding member 40e also extends down from the bottom of the packet toward the lidstock. The protruding member specifically extends just beyond the opening of the lidstock. As shown in FIG. 23D, once the ingestible material is filled in the packet, the lidstock is closed which causes the protruding member to curve towards a notch 40d formed at the point of the lidstock to maintain the lidstock in a closed state. To release the ingestible material, the lid structure is released by the notch which releases the curved state of the protruding member. Accordingly, the protruding member pushes the lidstock open thus releasing the ingestible materials stored therein.

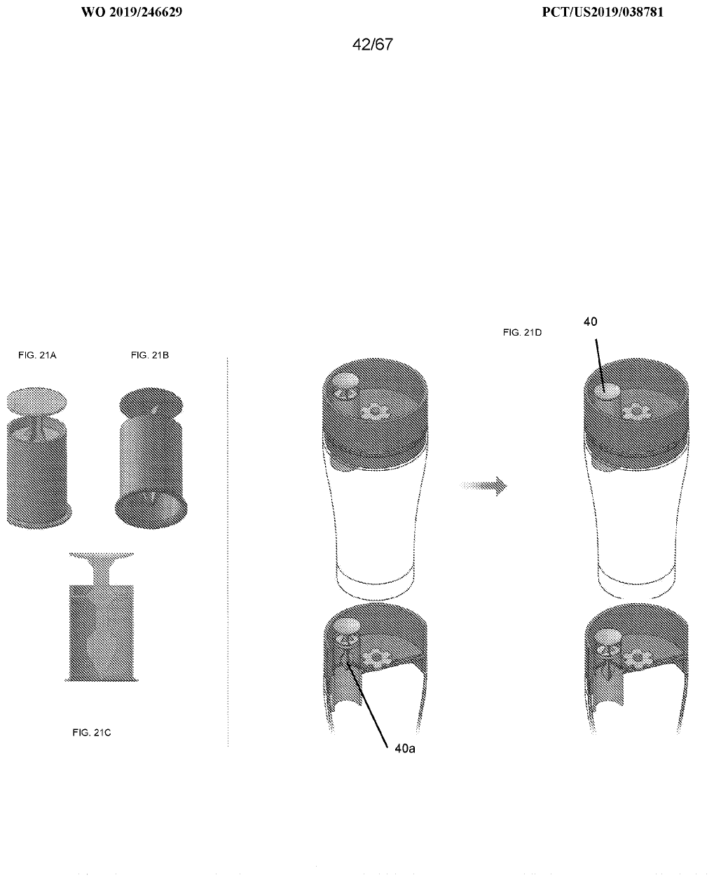

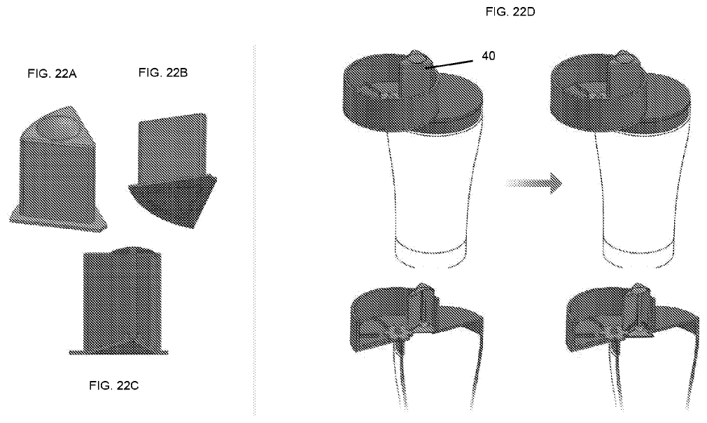

FIGS. 24A-24C illustrate an injection molded packet having a substantially wedge shape. In this configuration, the bottom of the packet may have a dome shape. Additionally, a protruding member extends from a center of the dome within the packet toward the lidstock side. The protruding member 40a comprises a plurality of fins at an end thereof. As shown in FIG. 24D, to dispense the ingestible materials into the vessel component, the rotation of the dispenser compartment causes the protruding member to push down on the lidstock and the fins thereof pierce through the lidstock to release the ingestible materials.

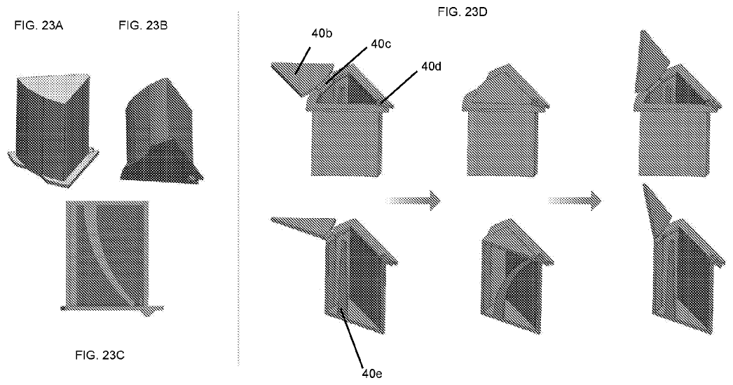

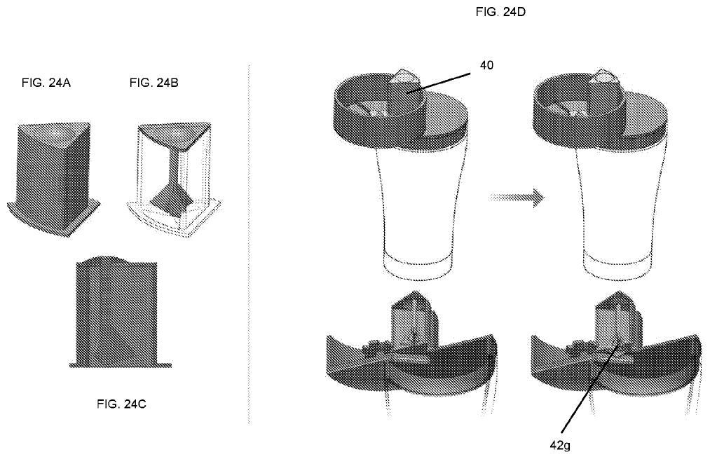

FIGS. 25A-25C illustrate an injection molded packet having a substantially wedge shape. In this configuration, the packet may be formed of multiple layers. For example, an inner layer, and an outer layer 40f having long apertures formed through the sides thereof and coupled to the lid of the packet. As shown in FIG. 25D, the outer layer of the packet may be pushed down into the vessel component with the inner layer remaining in the dispenser component. Accordingly, the ingestible material may be released through the long apertures of the outer layer. The coupling of the outer layer and the lid means the lid is also pushed down into the vessel component, opening the inner layer containing the ingestible materials. For example, each corner of the bottom of the packet may comprise a rod 40g and each rod may be communication with the outer layer of the packet to push the outer layer into the vessel component. This configuration may be useful in a desired slow release of an ingestible material.

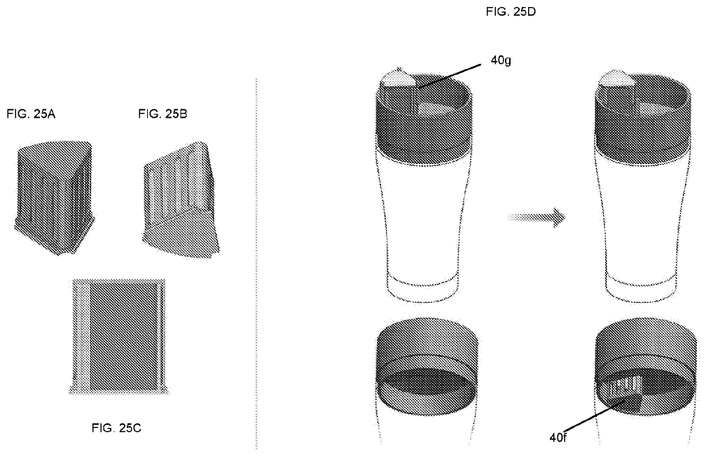

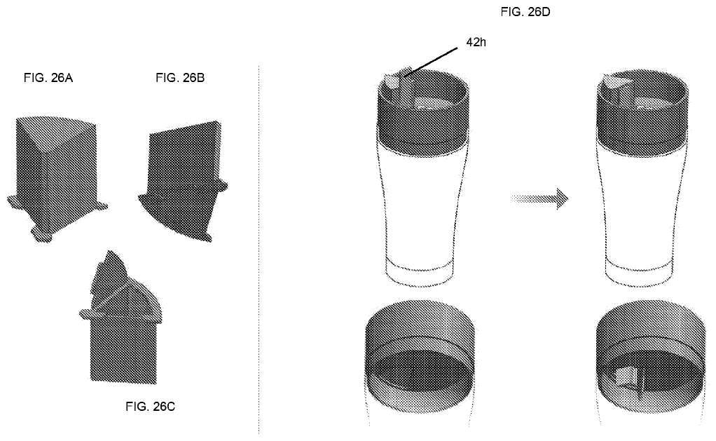

FIGS. 26A-26C illustrate an injection molded packet having a substantially wedge shape and a hinged lid structure similar to FIGS. 23A-23C. However, in this configuration, the lidstock is hinged on a side of the wedge shaped packet. The opening side of the lid structure also has a flange extending beyond the packet width. As shown in FIG. 26D, the dispenser component may comprise a bar member 42h extending up from a dispensing station. Once the packet is disposed at the dispensing station, the bar member may push down on the flange of the lid structure to push the lidstock open and release the ingestible materials into the vessel component.

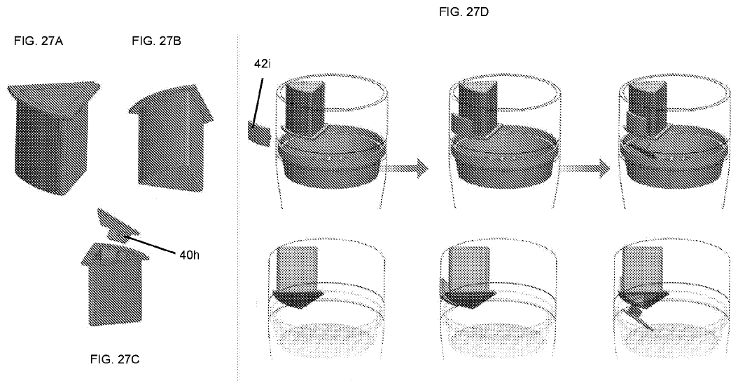

FIGS. 27A-27C illustrate an injected molded packet having a substantially wedge shape. In this configuration, the lid of the packet is formed as a separate component from the packet and is fitted thereinto. The lid structure includes a protrusion 40h that extends up into the packet. At a corresponding location, the packet includes two slits. As shown in FIG. 27D, a release component 42i is included in the dispenser component. This release component comprises two protrusions that correspond to the slits of the packet. Thus, when the release component is coupled to the packet, the protrusions of the release component are inserted into the packet slits which pushes the protrusion of the lid structure causing the lid to release from the packet. This configuration may additionally include a mesh or screen structure formed below the dispenser component. Thus, the lid structure is captured by the mesh structure preventing it from entering the fluid within the vessel component while still allowing the ingestible materials to flow thereinto.

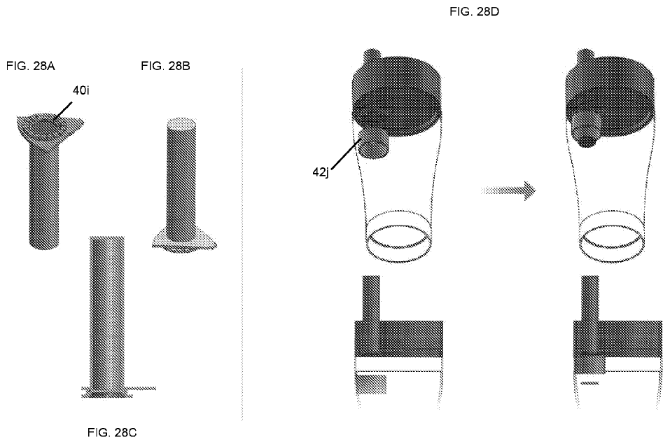

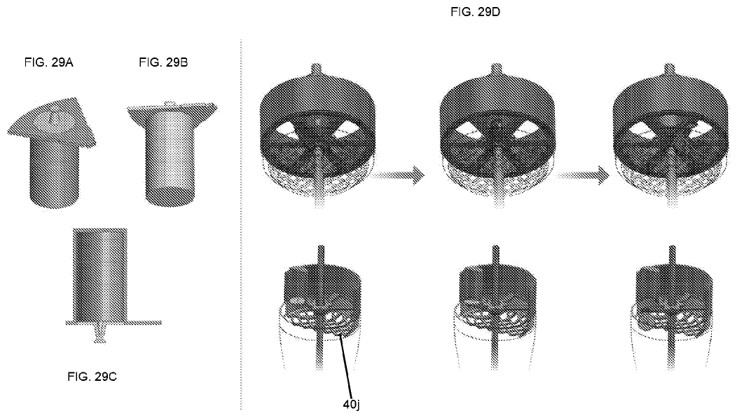

FIGS. 28A-28C illustrate an injection molded packet having a substantially cylindrical shape. In this configuration, the lid side of the packet comprises a triangular shaped flange extending from the packet. Attached to the flange is a retaining ring 40i having a plurality of ribs. As shown in FIG. 28D, the packet is loaded into the dispenser component with the flange and retaining ring sitting below the disk structure of the dispenser component. To release the ingestible materials, a bore component 42j within the dispenser component is pushed up against the retaining ring. In response thereto, a ring shaped portion of the lid of the packet is pushed through the bore to open the packet and release the ingestible materials into the vessel component.

FIGS. 29A-29C illustrate an injection molded packet having a substantially cylindrical shape and a triangular shaped flange as described in FIGS. 28A-28C. However, in this configuration, a circular lid structure is pressed fitted into the flange portion of the packet to close the packet. The lid structure also comprises a knob extending therefrom. When loaded in the rotor, the knob extends below the rotor into the dispenser component. As shown in FIG. 29D, the dispenser component may be formed with a mesh or nest layer 40j formed at a lower portion thereof. Additionally, an extending arm with a hook at an end thereof may be disposed underneath the rotor and rotates together with the rotor. Upon rotation of the rotor, the hook end of the extending arm catches the knob of the lid to separate the lid from the packet thus releasing the ingestible materials. The lid itself is caught in the mesh structure, preventing it from falling into the vessel component.

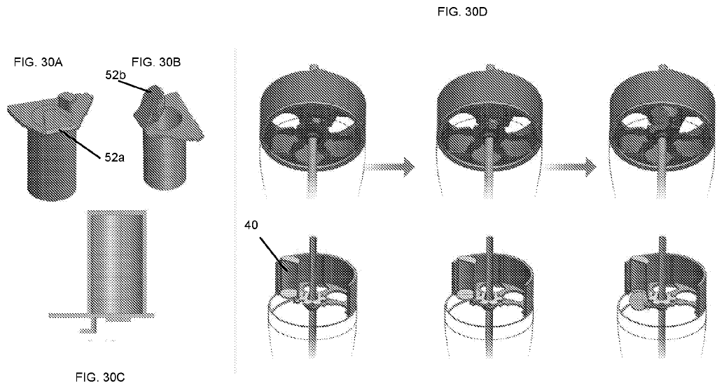

FIGS. 30A-30C illustrate an injection molded packet having a substantially cylindrical packet and a substantially triangular flange. In this configuration, one corner 52a of the flange is folded over the opening of the packet to close the packet with a circular lid structure 52b. The lid structure also comprises an L-shaped protrusion which extends below the rotor into the dispenser component when loaded in the rotor. Similar to FIG. 29D and as shown in FIG. 30D, the rotor comprises an extending arm therebelow with a hook at an end thereof. Upon rotation of the rotor, the hook of the extending arm catches the L-shaped protrusion of the lid and separates the lid from the packet thus opening and releasing the ingestible materials. However, in this configuration, a mesh structure is omitted since the lid remains connected to the folded corner of the flange.

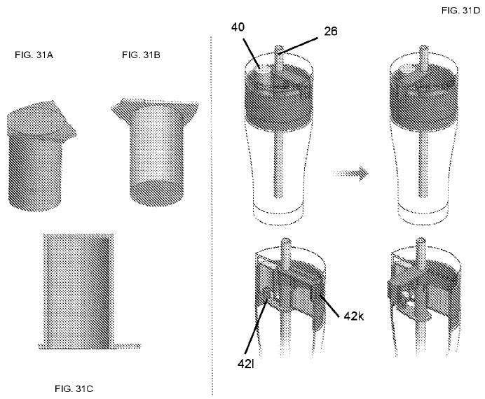

FIGS. 31A-31C illustrate an injection molded packet having a cylindrical packet with a substantially triangular flange. In this configuration, a tube extends through a center of the portable dispensing apparatus. Connected thereto in the dispenser apparatus is a ram needle 421 and a ram actuator 42k. The ram actuator extends to protrude outside of the dispenser apparatus. To actuate the ram needle, that is, to cause the ram needle to puncture through the packet within the dispenser component, a user may slide the ram actuator along an outer circumference of the dispenser apparatus. This rotation of the ram actuator simultaneously causes the ram needle to push up into the lidstock of the packet and release the ingestible materials into the vessel component.

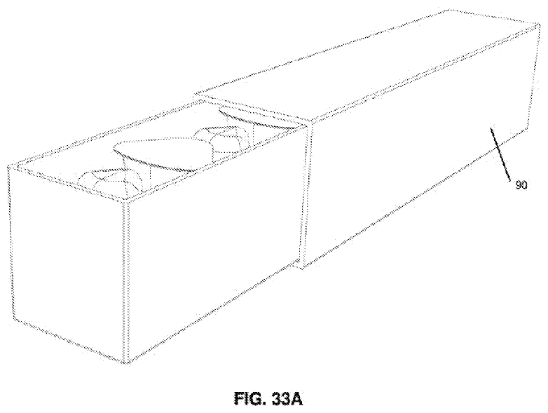

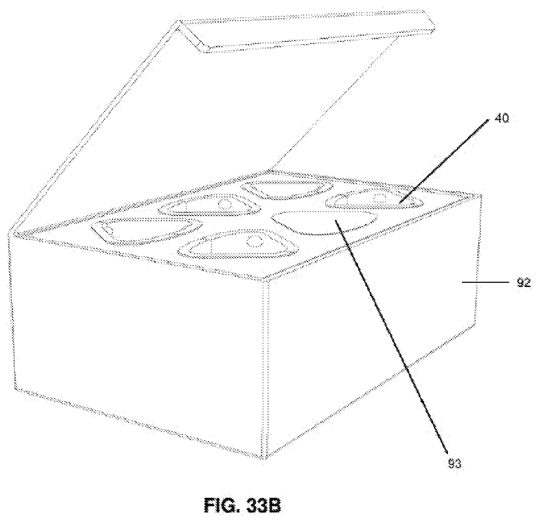

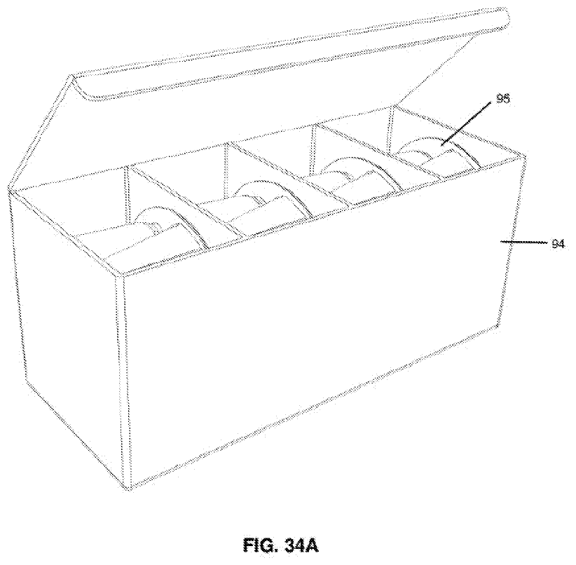

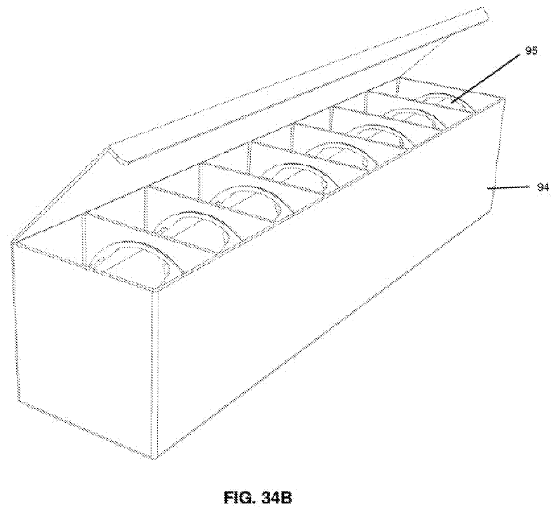

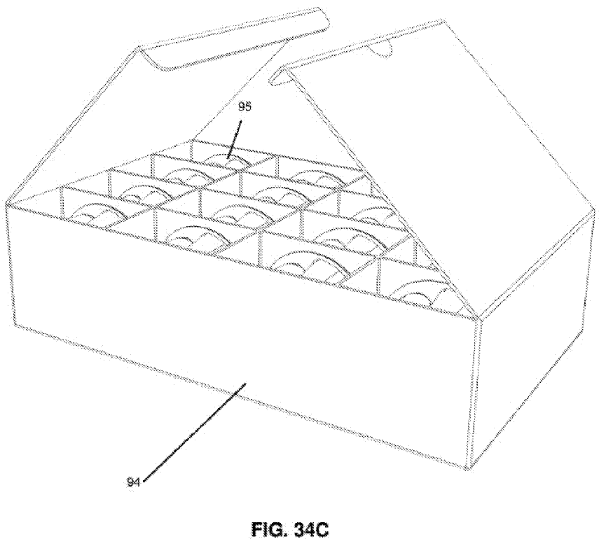

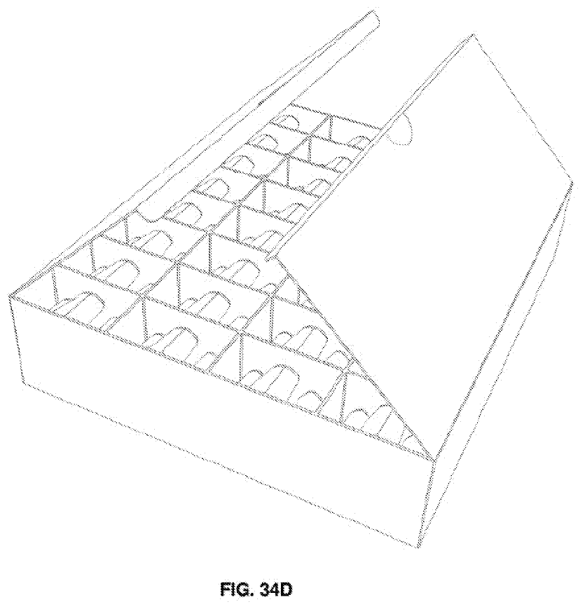

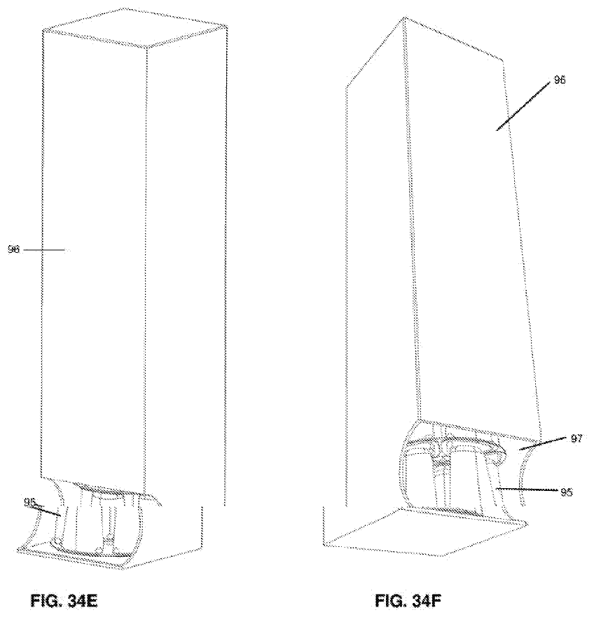

FIGS. 33-34 illustrate various embodiments of a packaging unit configured to accommodate the packets and rotor as described above. In particular, FIG. 33 illustrates a packaging unit configured to hold a plurality of packets in a sleeve 90. As shown, the pods may be nested in alternating orientation to prevent the lidstock of each pod from being inadvertently pierced. Any number of pods may be housed in the sleeve 90. FIG. 33B illustrates another embodiment in which pods are housed in individual inserts within a box 92. For example, the box contains a particular number of cavities 93 configured to receive a pod 40. This provides protection for each individual pod.

FIGS. 34A-34F illustrate various embodiments of a packaging unit configured to house rotors 95 having pods nested therein. As shown in FIGS. 34A-34D, the loaded rotors may be housed in a sleeve or box type unit 94 containing a variable number of rows for the rotors. The boxes may optionally be separated into a plurality of compartments to provide protection between the loaded rotors. FIGS. 34E-34F illustrate another embodiment in which the loaded rotors may be housed in vertical dispensing sleeves 96. For example, these sleeves may be optionally mounted vertically to allow for easy dispensing of a loaded rotor. As one loaded rotor is pulled out, a next one slides down to the opening slot 97. Optionally, the opening slot may comprise a door to provide further protection for the pods.

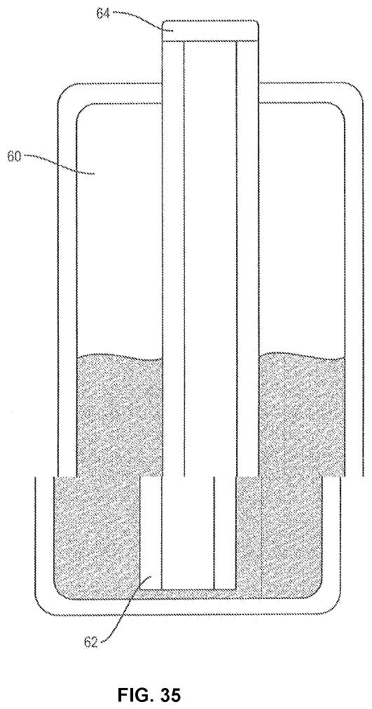

FIG. 35 depicts a further embodiment where the fluid dispensing apparatus comprises a separate fluid addition unit. Thus, as depicted in FIG. 35, fluid addition unit 60 suitably contains fluid for adding as desired to the vessel component on a fluid dispensing apparatus. Unit 60 suitably includes a supply line or other supply configuration 62 to admit fluid into the unit and a one-way port 64 for flow of fluid as desired into a vessel component of a fluid dispensing apparatus. Unit 60 suitably may be plastic or other material and may be disposable after a single use, or may be reusable or recyclable.

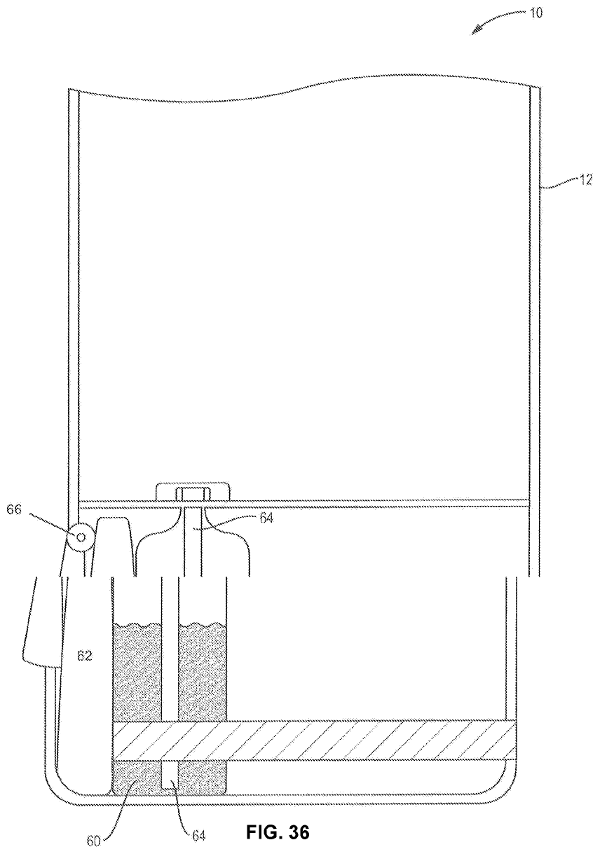

FIG. 36 shows fluid dispensing apparatus 10 with vessel component 12 outfitted with fluid addition unit 60. Air bladder 62 that may include air pump 66 is used in connection with fluid addition unit 60 to facilitate flow of fluid into vessel 12.

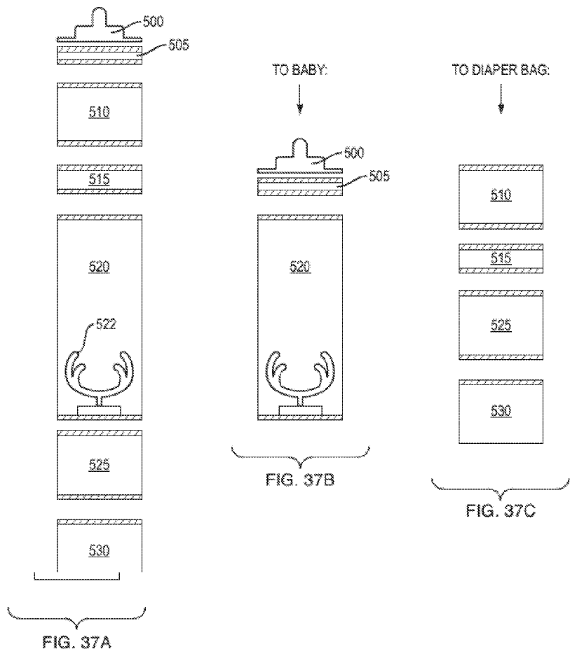

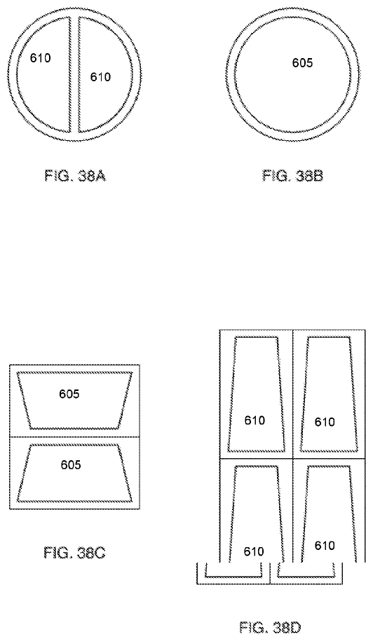

FIGS. 37A-37C and 38A-38D show a dispensing apparatus configured to dispense an infant formula. In particular, in this embodiment, the dispensing apparatus may include a nipple 500 provided at a top portion of the apparatus. The nipple 500 is fitted into and held in place by a nipple holder 505 which is attached (e.g. by threads or similar attachment method) to the dispensing head 510. The dispensing head 510 is attached to the piercing apparatus 515 configured to pierce pods of infant formula nested within the dispensing head 510. The nipple holder 505, the dispensing head 510, and piercing apparatus 515 are together attached to the bottle or vessel component 520. A blender 522 may be mounted at a bottom of the bottle component 520 to mix the dispensed infant formula with water or other fluid contained in the bottle component 520.

Additionally, attached to a bottom of the bottle component 520 is a base component 525. The base component 525 may comprise a motor, a battery, a UV-C light, and a heater. In particular, the motor is driven to operate the blender 522 in the bottle component 520. The UV-C light is used to sterilize water that is filled in the bottle component 520 prior to the dispensing of the infant formula. The heater or heating element in the base component is used to heat the formula to an optimal temperature (e.g., 95° F.). Below the base component 525 may be a sterilization chamber 530. This chamber may also comprise a UV-C light or other similar type of sterilization component. The nipple, pacifier, or other similar items, may be stored and sterilized in this chamber.

In this configuration, once the infant formula has been dispensed and blended with the fluid in the bottle component, various components may be detached before dispensing the blended fluid to an infant, as shown in FIG. 37B. Particularly, the dispensing head, the piercing apparatus, the base component, and the sterilization chamber may all be detached from the dispensing apparatus. Accordingly, the apparatus may provide an infant bottle comprising a nipple, nipple holder, and bottle compartment. A s shown in FIG. 37C, the dispensing head, the piercing apparatus, the base component, and the sterilization chamber may be attached to each other and stored during use of the dispensing apparatus.

FIGS. 38A-38D illustrate the storage of pods within the dispensing head of FIG. 37A. In particular, FIGS. 37A-37B illustrate a top view of the dispensing head and FIGS. 37C-37D illustrate side views thereof. For example, the dispensing head may store round pods 605 or semi-circular shaped pods 610, however, the embodiment is not limited thereto and any shaped pod as described herein may be used with this configuration. The dispending head may be divided into an upper chamber and a lower chamber, each accommodating pods. For example, FIG. 38C illustrates two round pods stored, one stored in an upper chamber and one stored in the lower chamber for dispensing into the bottle component. As another example, FIG. 38D illustrates four semi-circular pods, two stored in the upper chamber and two stored in the lower chamber for dispensing into the bottle component.

1-51. (canceled)

52. A packet comprising one or more ingestible materials and configured for use in a dispensing unit of a portable fluid dispensing apparatus,
wherein:
(i) the packet comprises one or more indicators, wherein the indicators are visual and/or tactile indicators;
(ii) the packet is deteably labeled; and/or
(iii) the packet comprises one or more protrusions for releasably engaging the fluid dispensing unit.

53. The packet of claim 52 wherein the packet comprises one or more indicator.

54. The packet of claim 53 wherein the indicators are color, textual or shape-coded.

55. The packet of claim 52 wherein the packet is detectably labeled.

56. The packet of claim 55 wherein the packet comprises contacts/dots, a QR code, or an RFID chip enabling the dispensing apparatus to sense the ingestible material dispensed at a particular time.

57. The packet of claim 52 wherein the packet comprises one or more protrusions for releasably engaging the fluid dispensing unit.

58. The packet of claim 52 wherein the longest dimension of the packet is less than 3 inches.

59. The packet of claim 52 wherein the packet is wedge shaped.

60. The packet of claim 52 wherein the packet comprises a flange portion to engage with the dispensing unit.

61. The packet of claim 52 wherein the packet comprises a lidstock for access to the one or more ingestible materials.

62. The packet of claim 61 wherein the packet lidstock is peelable.

63. The packet of claim 61 wherein the packet lidstock is scored on at least two sides.

64. The packet of claim 61 wherein the packet lidstock is piercable.

65. The packet of claim 61 wherein the packet lidstock is piercable with a leading edge of the packet remaining intact and wherein the pierced packet lidstock drags during rotation of a central disk structure of the dispensing unit to prevent inhibiting the rotation.

66. The packet of claim 61 wherein the lidstock comprises a QR code, a lot code, a bar code, or consumer readable information.

67. The packet of claim 52 wherein the packet is made from one or more materials that comprise a biodegradable polymer or a biocompostable polymer.

68. The packet of claim 60 wherein the packet is formed with an average draft angle between the flange and a packet bottom of less than about 5 degrees.

69. A packaging unit comprising a plurality of packets of claim 52.

70. The packaging unit of claim 69 wherein the packaging unit comprises at least 6 packets.
